(19) United States
(12) Patent Application Publication
(10) Pub. No.: US 2016/0074862 A1
(43) Pub. Date: Mar. 17, 2016

(54) CHEMICAL VAPOR DEPOSITION COATING FOR LABORATORY WARE

(71) Applicants: Jason Breaux, Auburn, AL (US); Daniel Ingram, Cherry Hill, NJ (US)

(72) Inventors: Jason Breaux, Auburn, AL (US); Daniel Ingram, Cherry Hill, NJ (US)

(73) Assignee: SiO2 Medical Products, Inc., Auburn, AL (US)

(21) Appl. No.: 14/511,352

(22) Filed: Oct. 10, 2014

Related U.S. Application Data
(60) Provisional application No. 61/890,044, filed on Oct. 11, 2013.

(51) Int. Cl. B01L 3/00; B01L 3/02

(52) U.S. Cl. CPC B01L 3/5085; B01L 3/0275; B01L 3/5021; B01L 2200/12; B01L 2300/163; B01L 2300/0829; B01L 2300/168

(57) ABSTRACT

An article of laboratory ware is disclosed comprising a body and a chemical vapor deposition coating. The body is made of thermoplastic material (“thermoplastic” includes glass or polymer resins) having a support surface. The chemical vapor deposition coating is applied directly or indirectly on the support surface. The coating defines a contact surface having a wetting tension of from 20 to 75 dyne/cm, for example. Useful wetting tensions beyond this range are contemplated as well.

Priority is claimed to U.S. Ser. No. 61/890,044, filed Oct. 11, 2013, and incorporated here by reference in its entirety.

### BACKGROUND

The present development relates generally to laboratory ware, sometimes also known as labware, laboratory glassware, or laboratory plastic ware. Labware includes microplates, centrifuge tubes, pipette tips, microwell plates, ELISA plates, microtiter plates, 96 well plates, and 384 well plates, which are several non-limiting examples.

The present development relates more particularly to chemical vapor deposition coatings for laboratory ware to improve its sample-contact characteristics, for example to adapt it for contact with protein or other peptide or polypeptide samples.

Biotechnology in vitro testing is commonly carried out on special-purpose laboratory glassware and plastic ware to contain and locate the test samples. Traditionally glassware was used, and continues to be used, but glassware is readily breakable, very expensive, prone to particulate problems, yields heavy metal extractables, and can cause aggregation of proteins and other biologics.

Some of these problems can be addressed by substituting injection molded plastic ware for glassware. In particular, plastic ware is preferred in the biologics area, due to the large number of issues with glassware. Plastic ware addresses some of the problems with glassware, but plastic ware creates certain problems as well. It can cause non-specific binding of biologics and contain leachables, preventing the use of plastic ware or making it undesirable for sensitive tests.

One compromise approach has been to employ plastic ware with glass inserts to cover the surfaces making contact with the samples. Unfortunately, plastic plates with glass inserts have most of the same issues as glass plates.

In addition, pipette tips and centrifuge tube are other types of laboratory ware used to prepare samples, and again can be glassware or plastic ware. Surfaces of these and other types of laboratory ware components made of polymeric plastic can cause non-specific binding of the samples. Surfaces of these and other types of labware components made of glass can cause particulate problems, have heavy metal extractables, and can cause aggregation of proteins and other biologics.

Some pertinent references are: U.S. Publ. Appl. No. U.S. Pat. No. 8,475,886; U.S. Publ. Appl. No. 2012/0252709; Khoren Sahagian, Mikki Lamer, and Stephen L. Kaplan, Altering Biological Interfaces with Gas Plasma: Example Applications, SURFACTS IN BIOMATERIALS, Summer 2013, 18(3); and Khoren Sahagian, Mikki Lamer, and Stephen L. Kaplan, Cold Gas Plasma in Surface Modification of Medical Plastics, a paper presented at SPE Antec Medical Plastics Division, Apr. 23, 2013; each of which is incorporated here by reference.

### SUMMARY

An aspect of the invention is an article of laboratory ware comprising a body and a chemical vapor deposition coating. The body is made of thermoplastic material (“thermoplastic” includes glass or polymer resins) having a support surface. The chemical vapor deposition coating is applied directly or indirectly on the support surface. The coating defines a contact surface having a wetting tension of from 20 to 75 dyne/cm, for example. Useful wetting tensions beyond this range are contemplated as well.

### BRIEF DESCRIPTION OF DRAWING FIGURES

FIG. 1 is a perspective view of an injection molded microplate according to an embodiment of the invention.

FIG. 2 is an exploded perspective view of an injection molded centrifuge tube and cap according to an embodiment of the invention.

FIG. 3 is a side elevation view of an injection molded pipette tip according to an embodiment of the invention.

FIG. 4 is a perspective view of an injection molded ELISA plate according to an embodiment of the invention.

FIG. 5 is a perspective schematic view of an injection molded microtiter plate according to an embodiment of the invention.

FIG. 6 is a plan view of an injection molded 96-well plate according to an embodiment of the invention.

FIG. 7 is a plan view of an injection molded 384-well plate according to an embodiment of the invention.

FIG. 8 is an enlarged detail view of the 384-well plate of FIG. 7.

FIG. 9 is a schematic detail view of an embodiment with more than one coating.

FIG. 10 is a schematic longitudinal section of an embodiment of tubing.

The following reference characters are used in the specification and Figures. Like reference characters represent like or similar parts.

| | | | |
|---|---|---|---|
| 20 | Article of laboratory ware | 40 | Top plate |
| 22 | Body (of 20) | 52 | Aperture |
| 24 | Well | 54 | Wall |
| 26 | Support surface | 56 | Index letter |
| 28 | Chemical vapor deposition coating | 58 | Index number |
| 30 | Contact surface | 60 | ELISA plate |
| 32 | Plate | 62 | Micotiter plate |
| 34 | Vessel | 64 | 96-well plate |
| 36 | Tubing | 66 | 384-well plate |
| 38 | Microplate | 68 | Lumen |
| 40 | Centrifuge tube | 70 | Interior surface |
| 42 | Pipette tip | 72 | Tie layer |
| 44 | Microwell plate | 74 | Barrier layer |
| 46 | Sample | 76 | pH protective layer |

| | |
|---|---|
| 48 | Base plate |

### DETAILED DESCRIPTION

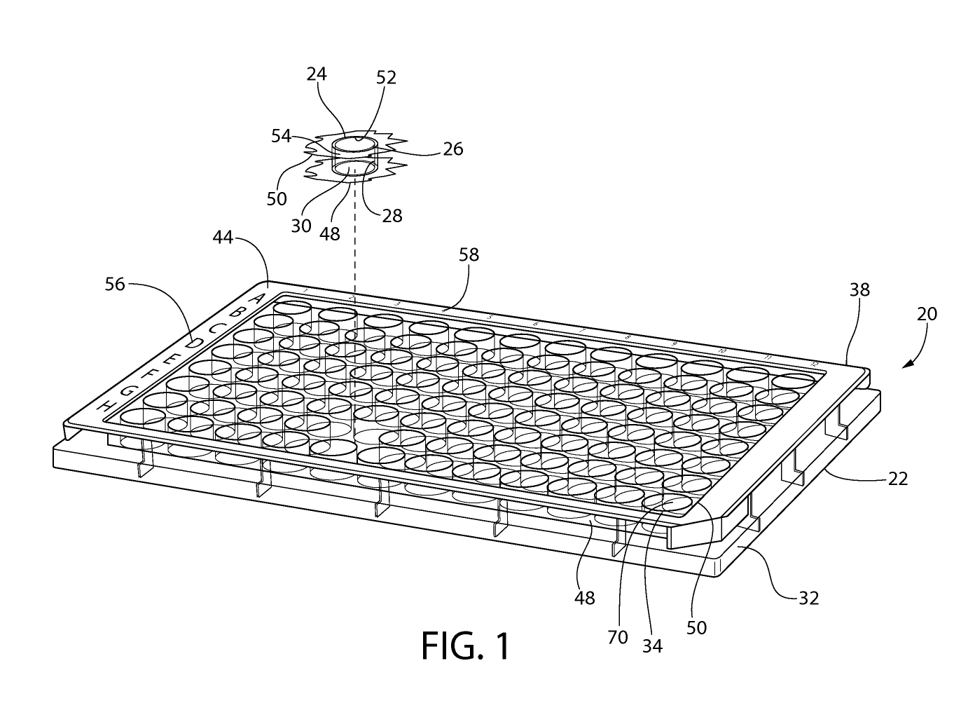

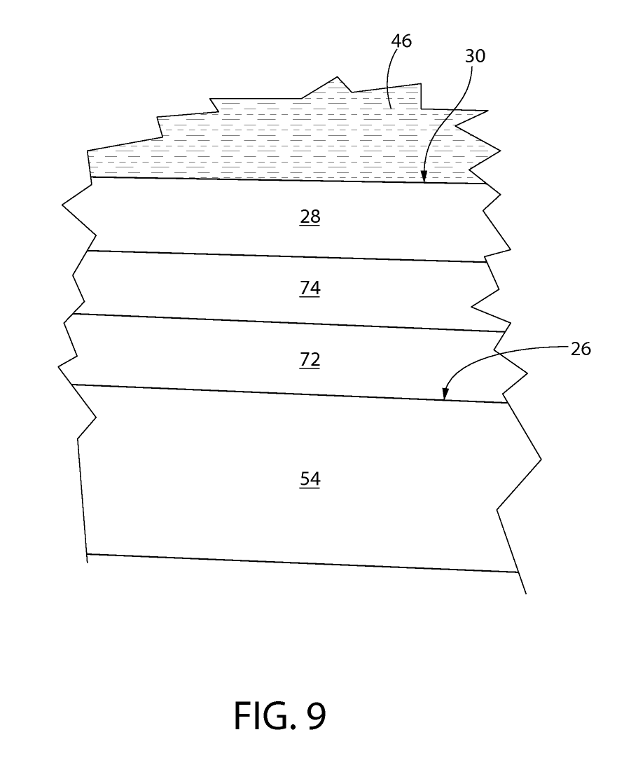

Referring to FIG. 1, the illustrated article of laboratory ware 20 comprises a body 22 made of thermoplastic material having a support surface 26 and a chemical vapor deposition coating 28. The chemical vapor deposition coating 28 is applied directly (as shown in FIG. 1) or indirectly (as shown in FIG. 9, showing an alternative usable in any embodiment) on the support surface 26. The coating 28 defines a contact surface 30 having a wetting tension of from 20 to 75 dyne/cm, for example. Useful wetting tensions beyond this range, either above or below it, are contemplated as well, for a situation in which those wetting tensions are useful.

In several alternatives useful in any embodiment, the contact surface 30 can have a wetting tension of from 20 to 25 dyne/cm, alternatively from 25 to 30 dyne/cm, alternatively from 30 to 35 dyne/cm, alternatively from 35 to 40 dyne/cm, alternatively from 40 to 45 dyne/cm, alternatively from 45 to 50 dyne/cm, alternatively from 50 to 55 dyne/cm, alternatively from 55 to 60 dyne/cm, alternatively from 60 to 65 dyne/cm, alternatively from 65 to 70 dyne/cm, alternatively from 70 to 75 dyne/cm.

A. Type of labware 20

In several alternatives useful in any embodiment, the article of laboratory ware 20 can be, or include, a plate 32, a vessel 34, or tubing 36.

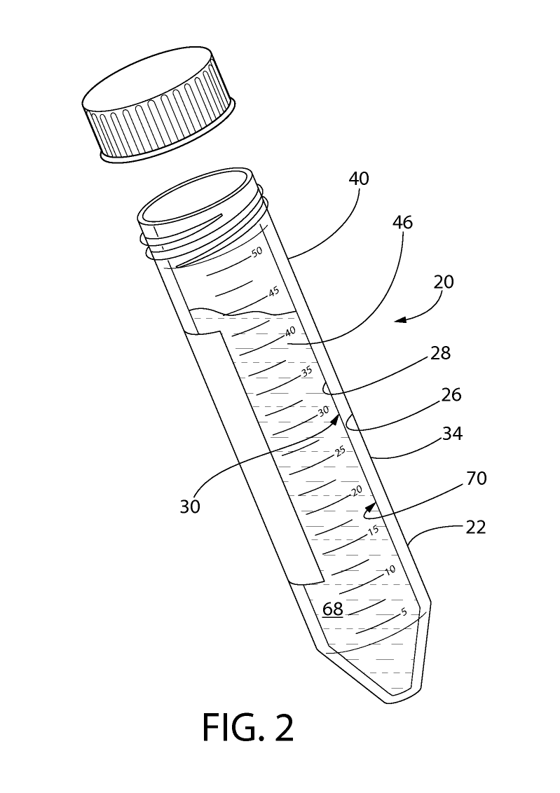

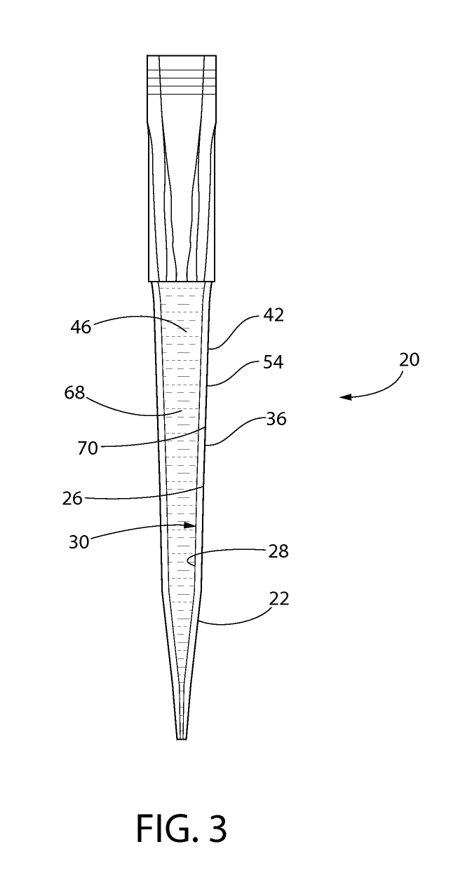

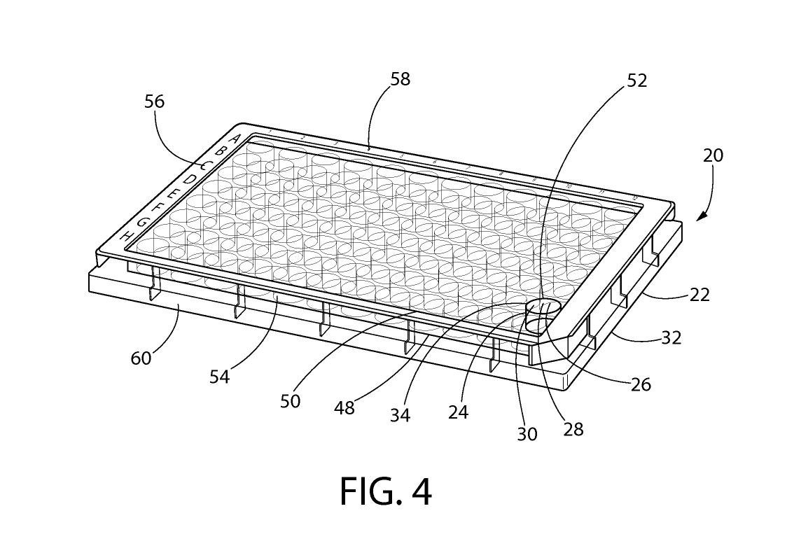

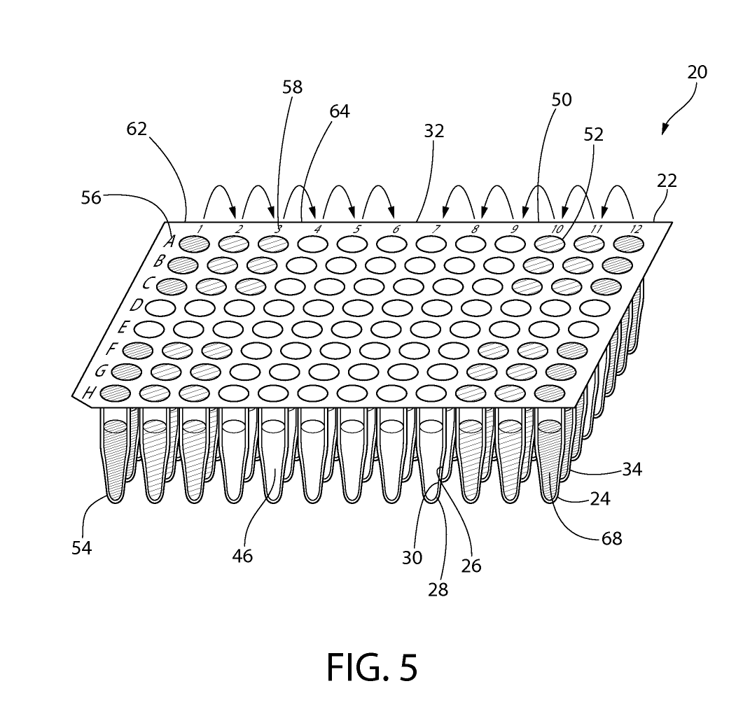

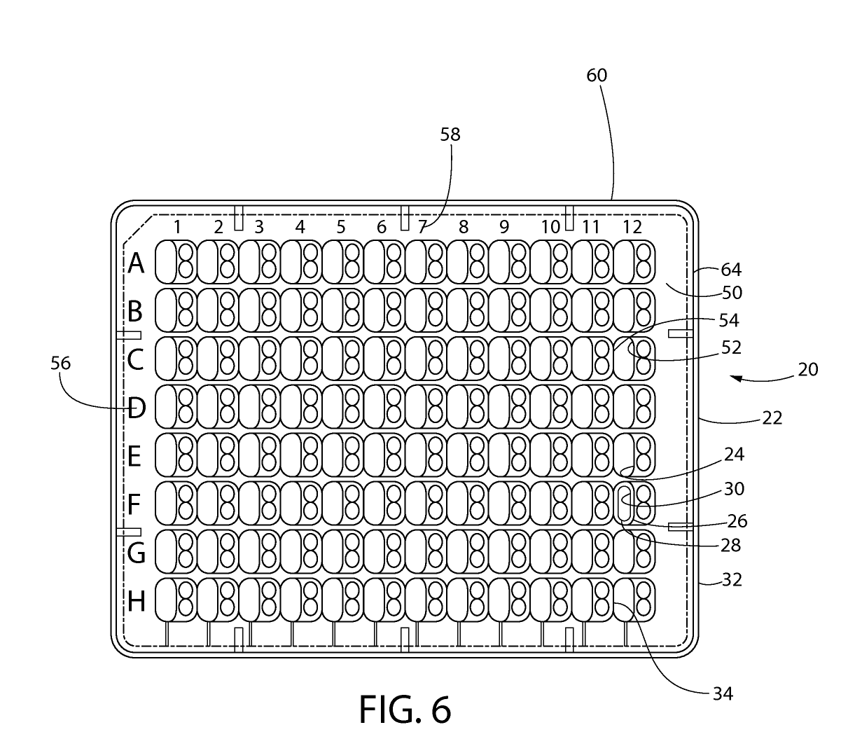

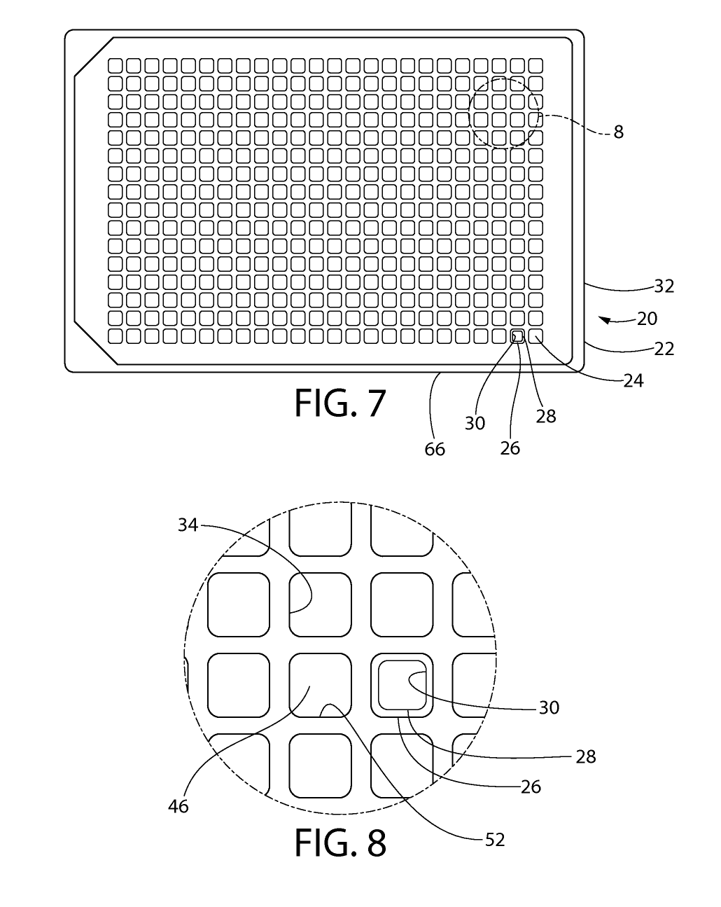

In several alternatives useful in any embodiment, the article of laboratory ware 20 can be any one or more of:
a microplate or microwell plate 38, as in FIG. 1;
a centrifuge tube 40, as in FIG. 2;
a pipette tip 42, as in FIG. 3;
an enzyme-linked immunosorbent assay (ELISA) plate 60, as in FIG. 4;
a microtiter plate 62, as in FIG. 5;
a 96-well plate 64, as in FIG. 6;
a 384-well plate 66, as in FIGS. 7 and 8; or
any type of laboratory ware, as exemplified in all of the Figures.

If configured as a plate 32, an alternative shown in FIGS. 1 and 4-9, the article of laboratory ware 20 can have a support surface 26 on which the contact surface 30 is supported. The support surface 26 can have a well 24—in the Examples of FIGS. 1 and 4-9, multiple wells 24—on which the contact surface 30 is supported.

In another alternative useful in any embodiment and illustrated in FIGS. 1, 2, and 4-9, the article of laboratory ware 20 can be configured to be (as in FIG. 2) or include as one or more components (as in FIGS. 1 and 4-9) a vessel 34. The vessel 34 has a lumen 68 defined by a wall 54 having an interior surface 70 configured for containing a sample 46, and at least a portion of the interior surface 70 is the support surface 26 on which the contact surface 30 is supported. One example of a vessel is each well such as 24 of the plates. Another example of a vessel 34 is the centrifuge tube of FIG. 2.

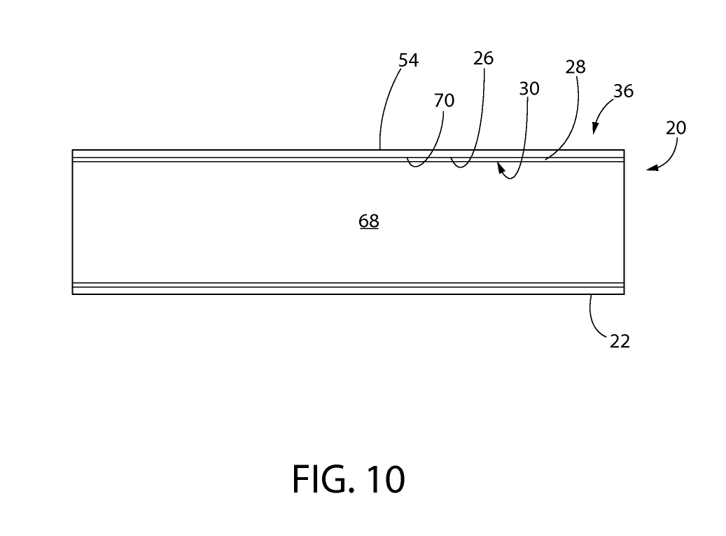

In another alternative useful in any embodiment and illustrated in FIGS. 3 and 10, the article of laboratory ware 20 comprises tubing 36. The tubing 36 has a lumen 68 defined by a wall 54 having an interior surface 70 configured for containing a sample 46, and at least a portion of the interior surface 70 is the support surface 26 on which the contact surface 30 is supported.

The pipette tip 42 of FIG. 3 is a specially adapted example of tubing. The pipette tip 42 has a lumen 68 defined by a wall 54 having an interior surface 70 configured for containing a sample 46 as the support surface 26 on which the contact surface 30 is supported.

### B. Type of Thermoplastic Material

The present articles of laboratory ware include a body 22 made of thermoplastic material. In the present disclosure, “thermoplastic material” is defined as including both glass and polymeric resin compositions. In certain embodiments, the polymeric resin compositions can be injection moldable resin compositions, which are preferred because injection molded containers can be made inexpensively, with narrow tolerances and a high level of automation. Several specific examples of the polymers from which thermoplastic compositions can be made, any of which are contemplated for any embodiment, are:
an olefin polymer;
polypropylene (PP);
polyethylene (PE);
cyclic olefin copolymer (COC);
cyclic olefin polymer (COP);
polymethylpentene;
polyester;
polyethylene terephthalate;
polyethylene naphthalate;
polybutylene terephthalate (PBT);
polyvinylidene chloride (PVdC);
polyvinyl chloride (PVC);
polycarbonate;
polylactic acid;
polystyrene;
hydrogenated polystyrene;
polycyclohexylethylene (PCHE);
epoxy resin;
nylon;
polyurethane polyacrylonitrile;
polyacrylonitrile (PAN);
an ionomeric resin;
Surlyn® ionomeric resin;
glass;
borosilicate glass.
   or a combination of any two or more of these.

### C. Type of Chemical Vapor Deposition Process

In the present articles of laboratory ware, a chemical vapor deposition coating 28 is applied directly or indirectly on the support surface 26: the coating 28 defines a contact surface 30. Any chemical vapor deposition process can be used to apply the chemical vapor deposition coating 28. Several examples of suitable processes follow.

One example of a chemical vapor deposition process useful in any embodiment is plasma enhanced chemical vapor deposition (PECVD).

PECVD apparatus and methods for depositing any of the coatings defined in this specification, for example the coatings comprising silicon, oxygen, and optionally carbon identified in this specification, are disclosed, for example, in WO2013/071,138, published May 16, 2013, which is incorporated here by reference.

Another example of a chemical vapor deposition process useful in any embodiment, which is a type of PECVD, is plasma impulse chemical vapor deposition (PICVD). Suitable equipment and processing conditions for PICVD can be found, for example, in U.S. Pat. No. 7,399,500.

Another example of a chemical vapor deposition process useful in any embodiment is pulsed plasma enhanced chemical vapor deposition (PPECVD). Suitable equipment and processing conditions for PPECVD can be found, for example, in S. J. Limb, K. K. S. Lau, D. J. Edell, E. F. Gleason, K. K. Gleason, Molecular Design Of Fluorocarbon Film Architecture By Pulsed Plasma Enhanced And Pyrolytic Chemical Vapor Deposition, PLASMA POLYMERIZATION 4 1999 21-32, which is incorporated here by reference.

Another example of a chemical vapor deposition process useful in any embodiment is pyrolytic chemical vapor deposition (PCVD). Suitable equipment and processing conditions for PCVD can be found, for example, in S. J. Limb, K. K. S. Lau, D. J. Edell, E. F. Gleason, K. K. Gleason, Molecular Design Of Fluorocarbon Film Architecture By Pulsed Plasma Enhanced And Pyrolytic Chemical Vapor Deposition, PLASMA POLYMERIZATION 4 1999 21-32, which is incorporated here by reference.

Another example of a chemical vapor deposition process useful in any embodiment is hot filament chemical vapor deposition, sometimes also known as hot wire chemical vapor deposition. Suitable equipment and processing conditions for hot filament chemical vapor deposition can be found, for example, in K. K. S. Lau, K. K. Gleason, Thermal Annealing Of Fluorocarbon Films Grown By Hot Filament Chemical Vapor Deposition, JOURNAL OF PHYSICAL CHEMISTRY B 105 2001 2303-2307; K. K. S. Lau, S. K. Murthy, H. G. Lewis, J. A. Caulfield, K. K. Gleason, Fluorocarbon Dielectrics Via Hot Filament Chemical Vapor Deposition, JOURNAL OF FLUORINE CHEMISTRY 122 2003 93-96, which are both incorporated here by reference.

Another example of a chemical vapor deposition process useful in any embodiment is pyrolysis of a precursor, for example of hexafluoropropylene oxide. Suitable equipment and processing conditions for pyrolysis can be found, for example, in J. Wang, X. Song, R. lia, J. Shen, G. Yang, H. Huang, Fluorocarbon Thin Film With Superhydrophobic Property Prepared By Pyrolysis Of Hexafluoropropylene Oxide, APPLIED SURFACE SCIENCE 258 2012 9782-9785, which is incorporated here by reference.

### D. Properties of CVD Coating 28

The contact surface 30 formed by the chemical vapor deposition coating 28 optionally can have many different properties and advantages, depending on how it is applied and the materials of the support surface 26 and the coating 28, and materials placed into contact with the contact surface 30. Some advantages that can be realized in certain embodiments of the technology are provided here. The disclosed or claimed technology is not limited, however, to embodiments implementing one or more of these advantages and features.

One optional advantage realized in certain embodiments is reduced non-specific binding of peptides to the chemical vapor deposition coating 28 compared to the support surface 26 before application of the chemical vapor deposition coating 28. (“Peptides” as used here include short amino acid sequences as well as polypeptides, and include but are not limited to proteins, native DNA sequences, native RNA sequences, or cDNA sequences.) A more particular advantage realized in certain embodiments is that the contact surface 30 formed by the chemical vapor deposition coating 28 has reduced non-specific binding of proteins compared to the support surface 26 before application of the chemical vapor deposition coating 28. Another optional advantage realized in certain embodiments is that the contact surface 30 formed by the chemical vapor deposition coating 28 has reduced aggregation of protein based products compared to the support surface 26 before application of the chemical vapor deposition coating 28. These advantages and how they can be realized are explained in Khoren Sahagian, Mikki Lamer, and Stephen L. Kaplan, Altering Biological Interfaces with Gas Plasma: Example Applications, SURFACTS IN BIOMATERIALS, Summer 2013, 18(3); and Khoren Sahagian, Mikki Lamer, and Stephen L. Kaplan, Cold Gas Plasma in Surface Modification of Medical Plastics, a paper presented at SPE Antec Medical Plastics Division, Apr. 23, 2013, which are incorporated here by reference.

Another optional advantage realized in certain embodiments is that the contact surface 30 formed by the chemical vapor deposition coating 28 has reduced metal contaminants that can enter a sample 46 contacting the contact surface 30, compared to the support surface 26 before application of the chemical vapor deposition coating 28.

Another optional advantage realized in certain embodiments is that the contact surface 30 formed by the chemical vapor deposition coating 28 has enhanced solvent resistance compared to the support surface 26 before application of the chemical vapor deposition coating 28. Examples of solvents to which resistance can be provided include plain water, water for injection, saline solution, water-based compositions having a pH between about 5 and 9, water containing one or more surfactants, as well as isopropanol or ethanol.

Another optional advantage realized in certain embodiments is that the contact surface 30 formed by the chemical vapor deposition coating 28 has reduced extractable compounds compared to the support surface 26 before application of the chemical vapor deposition coating 28. The thermoplastic compositions described here as useful may contain small proportions of metal ions, for example resulting from the use of metal catalysts or process equipment to make the thermoplastic resins or as components of the resin compositions, or as constituents of glass. The thermoplastic compositions described here as useful may contain small proportions of organic compounds such as monomeric or oligomeric residues of polymer formation or solvents such as water or isopropanol.

For one example, a barrier layer of SiOₓ, where x is from 1.5 to 2.9 as measured by XPS, alternatively described as one of Species 11 to 24 described in this specification, will reduce the level of the above-described extractables. For another example, a layer of SiOxCy or SiNxCy in which x is from about 0.5 to about 2.4 and y is from about 0.6 to about 3 as measured by XPS, for example the species within these numerical ranges described in this specification optionally can be used to provide reduced extractable compounds. Another optional advantage realized in certain embodiments is that the contact surface 30 formed by the chemical vapor deposition coating 28 has reduced leachable metal contaminants compared to the support surface 26 before application of the chemical vapor deposition coating 28.

Another optional advantage realized in certain embodiments is that the contact surface 30 formed by the chemical vapor deposition coating 28 has improved cleanliness, defined as reduced levels of foreign substances such as particulates, compared to the support surface 26 before application of the chemical vapor deposition coating 28. Another optional advantage realized in certain embodiments is that the contact surface 30 formed by the chemical vapor deposition coating 28 has reduced particulates compared to the support surface 26 before application of the chemical vapor deposition coating 28.

Another optional advantage realized in certain embodiments is that the support surface 26 combined with the contact surface 30 formed by the chemical vapor deposition coating 28 has optical properties, when performing analytical tests by transmitting light through the support surface, equivalent to or superior to glass and equal compared to the support surface 26 before application of the chemical vapor deposition coating 28.

Another optional advantage realized in certain embodiments is that the contact surface 30 formed by the chemical vapor deposition coating 28 provides low background noise in analytical testing compared to the support surface 26 before application of the chemical vapor deposition coating 28. This advantage is realized, for example, for labware having a support surface made of COC, COP, or polypropylene, versus conventional polystyrene and/or glass labware.

Another optional advantage realized in certain embodiments is that the support surface 26 is transparent and in combination with the contact surface 30 formed by the chemical vapor deposition coating 28 reduces birefringence of images viewed through the support surface 26. This advantage is realized, for example, for labware having a support surface made of COC, COP, or polypropylene, versus conventional polystyrene labware.

Another optional advantage realized in certain embodiments is that the contact surface 30 formed by the chemical vapor deposition coating 28 has higher performance than standard polystyrene plates for at least one of fluorescence assays, luminescence detection, or scintillation counting.

Another optional advantage realized in certain embodiments is that the support surface 26 is transparent and the contact surface 30 formed by the chemical vapor deposition coating 28 has higher performance, such as higher (smaller) resolution and less ghost imaging than standard polystyrene plates for high-resolution microscopy using confocal imaging. An introduction to confocal microscopy can be found in the Wikipedia® article of that name.

Another optional advantage realized in certain embodiments is that the contact surface 30 formed by the chemical vapor deposition coating 28 is a tissue culture promoting surface that increases the cell growth rate.

Another optional advantage realized in certain embodiments is that the support surface 26 is transparent and the contact surface 30 formed by the chemical vapor deposition coating 28 improves the clarity of a sample 46 viewed through the support surface 26, compared to a glass or polystyrene surface, for easy and exact positioning when used in combination with microscopes.

Another optional advantage realized in certain embodiments is that the contact surface 30 formed by the chemical vapor deposition coating 28 is flat to <100 microns.

Another optional advantage realized in certain embodiments is that the support surface 26, before or after formation of the chemical vapor deposition coating 28, has low well to well volume variability. This advantage is particularly realized when the labware is injection molded, as the tolerances for injection molding can be much smaller than for glass fabrication.

Another optional advantage realized in certain embodiments is that the contact surface 30 formed by the chemical vapor deposition coating 28 has a contact angle suitable for contact with a selected protein. The contact angle is a measure of how hydrophilic or hydrophobic the contact surface 30 is.

Another optional advantage realized in certain embodiments is that the contact surface 30 formed by the chemical vapor deposition coating 28 is configured for contact with a selected peptide. No limitation on the peptide is contemplated, but some exemplary peptides are human, animal, porcine, or synthetic insulin suitable for use as a human drug for treating diabetes.

In certain embodiments, the chemical vapor deposition coating 28 comprises SiOₓC_{y}, otherwise expressed as a composition of silicon, nitrogen or oxygen, and carbon in one of the following species of atomic ratios as measured by X-ray Photoelectron Spectroscopy XPS. Each of these species is individually contemplated as a chemical vapor deposition coating 28 according to the present technology.

| SPECIES | Si | O | C |
|---|---|---|---|
| 1 | 1 | 0.5 to 2.9 | 0 to 3 |
| 2 | 1 | 0.6 to 0.7 | 0 to 0.1 |
| 3 | 1 | 0.7 to 0.8 | 0 to 0.1 |
| 4 | 1 | 0.8 to 0.9 | 0 to 0.1 |
| 5 | 1 | 0.9 to 1.0 | 0 to 0.1 |
| 6 | 1 | 1.0 to 1.1 | 0 to 0.1 |
| 7 | 1 | 1.1 to 1.2 | 0 to 0.1 |
| 8 | 1 | 1.2 to 1.3 | 0 to 0.1 |
| 9 | 1 | 1.3 to 1.4 | 0 to 0.1 |
| 10 | 1 | 1.4 to 1.5 | 0 to 0.1 |
| 11 | 1 | 1.5 to 1.6 | 0 to 0.1 |
| 12 | 1 | 1.6 to 1.7 | 0 to 0.1 |
| 13 | 1 | 1.7 to 1.8 | 0 to 0.1 |
| 14 | 1 | 1.8 to 1.9 | 0 to 0.1 |
| 15 | 1 | 1.9 to 2.0 | 0 to 0.1 |
| 16 | 1 | 2.0 to 2.1 | 0 to 0.1 |
| 17 | 1 | 2.1 to 2.2 | 0 to 0.1 |
| 18 | 1 | 2.2 to 2.3 | 0 to 0.1 |
| 19 | 1 | 2.3 to 2.4 | 0 to 0.1 |
| 20 | 1 | 2.4 to 2.5 | 0 to 0.1 |
| 21 | 1 | 2.5 to 2.6 | 0 to 0.1 |
| 22 | 1 | 2.6 to 2.7 | 0 to 0.1 |
| 23 | 1 | 2.7 to 2.8 | 0 to 0.1 |
| 24 | 1 | 2.8 to 2.9 | 0 to 0.1 |
| 25 | 1 | 0.5 to 0.6 | 0.1 to 0.2 |
| 26 | 1 | 0.6 to 0.7 | 0.1 to 0.2 |
| 27 | 1 | 0.7 to 0.8 | 0.1 to 0.2 |
| 28 | 1 | 0.8 to 0.9 | 0.1 to 0.2 |
| 29 | 1 | 0.9 to 1.0 | 0.1 to 0.2 |
| 30 | 1 | 1.0 to 1.1 | 0.1 to 0.2 |
| 31 | 1 | 1.1 to 1.2 | 0.1 to 0.2 |
| 32 | 1 | 1.2 to 1.3 | 0.1 to 0.2 |
| 33 | 1 | 1.3 to 1.4 | 0.1 to 0.2 |
| 34 | 1 | 1.4 to 1.5 | 0.1 to 0.2 |
| 35 | 1 | 1.5 to 1.6 | 0.1 to 0.2 |
| 36 | 1 | 1.6 to 1.7 | 0.1 to 0.2 |
| 37 | 1 | 1.7 to 1.8 | 0.1 to 0.2 |
| 38 | 1 | 1.8 to 1.9 | 0.1 to 0.2 |
| 39 | 1 | 1.9 to 2.0 | 0.1 to 0.2 |
| 40 | 1 | 2.0 to 2.1 | 0.1 to 0.2 |
| 41 | 1 | 2.1 to 2.2 | 0.1 to 0.2 |
| 42 | 1 | 2.2 to 2.3 | 0.1 to 0.2 |
| 43 | 1 | 2.3 to 2.4 | 0.1 to 0.2 |
| 44 | 1 | 2.4 to 2.5 | 0.1 to 0.2 |
| 45 | 1 | 2.5 to 2.6 | 0.1 to 0.2 |
| 46 | 1 | 2.6 to 2.7 | 0.1 to 0.2 |
| 47 | 1 | 2.7 to 2.8 | 0.1 to 0.2 |
| 48 | 1 | 2.8 to 2.9 | 0.1 to 0.2 |
| 49 | 1 | 0.5 to 0.6 | 0.2 to 0.3 |
| 50 | 1 | 0.6 to 0.7 | 0.2 to 0.3 |
| 51 | 1 | 0.7 to 0.8 | 0.2 to 0.3 |
| 52 | 1 | 0.8 to 0.9 | 0.2 to 0.3 |
| 53 | 1 | 0.9 to 1.0 | 0.2 to 0.3 |
| 54 | 1 | 1.0 to 1.1 | 0.2 to 0.3 |
| 55 | 1 | 1.1 to 1.2 | 0.2 to 0.3 |
| 56 | 1 | 1.2 to 1.3 | 0.2 to 0.3 |
| 57 | 1 | 1.3 to 1.4 | 0.2 to 0.3 |
| 58 | 1 | 1.4 to 1.5 | 0.2 to 0.3 |
| 59 | 1 | 1.5 to 1.6 | 0.2 to 0.3 |
| 60 | 1 | 1.6 to 1.7 | 0.2 to 0.3 |
| 61 | 1 | 1.7 to 1.8 | 0.2 to 0.3 |
| 62 | 1 | 1.8 to 1.9 | 0.2 to 0.3 |
| 63 | 1 | 1.9 to 2.0 | 0.2 to 0.3 |
| 64 | 1 | 2.0 to 2.1 | 0.2 to 0.3 |
| 65 | 1 | 2.1 to 2.2 | 0.2 to 0.3 |
| 66 | 1 | 2.2 to 2.3 | 0.2 to 0.3 |
| 67 | 1 | 2.3 to 2.4 | 0.2 to 0.3 |
| 68 | 1 | 2.4 to 2.5 | 0.2 to 0.3 |
| 69 | 1 | 2.5 to 2.6 | 0.2 to 0.3 |
| 70 | 1 | 2.6 to 2.7 | 0.2 to 0.3 |
| 71 | 1 | 2.7 to 2.8 | 0.2 to 0.3 |
| 72 | 1 | 2.8 to 2.9 | 0.2 to 0.3 |
| 73 | 1 | 0.5 to 0.6 | 0.3 to 0.4 |
| 74 | 1 | 0.6 to 0.7 | 0.3 to 0.4 |
| 75 | 1 | 0.7 to 0.8 | 0.3 to 0.4 |
| 76 | 1 | 0.8 to 0.9 | 0.3 to 0.4 |
| 77 | 1 | 0.9 to 1.0 | 0.3 to 0.4 |
| 78 | 1 | 1.0 to 1.1 | 0.3 to 0.4 |
| 79 | 1 | 1.1 to 1.2 | 0.3 to 0.4 |
| 80 | 1 | 1.2 to 1.3 | 0.3 to 0.4 |
| 81 | 1 | 1.3 to 1.4 | 0.3 to 0.4 |
| 82 | 1 | 1.4 to 1.5 | 0.3 to 0.4 |
| 83 | 1 | 1.5 to 1.6 | 0.3 to 0.4 |
| 84 | 1 | 1.6 to 1.7 | 0.3 to 0.4 |
| 85 | 1 | 1.7 to 1.8 | 0.3 to 0.4 |
| 86 | 1 | 1.8 to 1.9 | 0.3 to 0.4 |
| 87 | 1 | 1.9 to 2.0 | 0.3 to 0.4 |
| 88 | 1 | 2.0 to 2.1 | 0.3 to 0.4 |
| 89 | 1 | 2.1 to 2.2 | 0.3 to 0.4 |
| 90 | 1 | 2.2 to 2.3 | 0.3 to 0.4 |
| 91 | 1 | 2.3 to 2.4 | 0.3 to 0.4 |
| 92 | 1 | 2.4 to 2.5 | 0.3 to 0.4 |
| 93 | 1 | 2.5 to 2.6 | 0.3 to 0.4 |
| 94 | 1 | 2.6 to 2.7 | 0.3 to 0.4 |
| 95 | 1 | 2.7 to 2.8 | 0.3 to 0.4 |
| 96 | 1 | 2.8 to 2.9 | 0.3 to 0.4 |
| 97 | 1 | 0.5 to 0.6 | 0.4 to 0.5 |
| 98 | 1 | 0.6 to 0.7 | 0.4 to 0.5 |
| 99 | 1 | 0.7 to 0.8 | 0.4 to 0.5 |
| 100 | 1 | 0.8 to 0.9 | 0.4 to 0.5 |
| 101 | 1 | 0.9 to 1.0 | 0.4 to 0.5 |
| 102 | 1 | 1.0 to 1.1 | 0.4 to 0.5 |
| 103 | 1 | 1.1 to 1.2 | 0.4 to 0.5 |
| 104 | 1 | 1.2 to 1.3 | 0.4 to 0.5 |
| 105 | 1 | 1.3 to 1.4 | 0.4 to 0.5 |
| 106 | 1 | 1.4 to 1.5 | 0.4 to 0.5 |
| 107 | 1 | 1.5 to 1.6 | 0.4 to 0.5 |
| 108 | 1 | 1.6 to 1.7 | 0.4 to 0.5 |
| 109 | 1 | 1.7 to 1.8 | 0.4 to 0.5 |
| 110 | 1 | 1.8 to 1.9 | 0.4 to 0.5 |
| 111 | 1 | 1.9 to 2.0 | 0.4 to 0.5 |
| 112 | 1 | 2.0 to 2.1 | 0.4 to 0.5 |
| 113 | 1 | 2.1 to 2.2 | 0.4 to 0.5 |
| 114 | 1 | 2.2 to 2.3 | 0.4 to 0.5 |
| 115 | 1 | 2.3 to 2.4 | 0.4 to 0.5 |
| 116 | 1 | 2.4 to 2.5 | 0.4 to 0.5 |
| 117 | 1 | 2.5 to 2.6 | 0.4 to 0.5 |
| 118 | 1 | 2.6 to 2.7 | 0.4 to 0.5 |
| 119 | 1 | 2.7 to 2.8 | 0.4 to 0.5 |
| 120 | 1 | 2.8 to 2.9 | 0.4 to 0.5 |
| 121 | 1 | 0.5 to 0.6 | 0.5 to 0.6 |
| 122 | 1 | 0.6 to 0.7 | 0.5 to 0.6 |
| 123 | 1 | 0.7 to 0.8 | 0.5 to 0.6 |
| 124 | 1 | 0.8 to 0.9 | 0.5 to 0.6 |
| 125 | 1 | 0.9 to 1.0 | 0.5 to 0.6 |
| 126 | 1 | 1.0 to 1.1 | 0.5 to 0.6 |
| 127 | 1 | 1.1 to 1.2 | 0.5 to 0.6 |
| 128 | 1 | 1.2 to 1.3 | 0.5 to 0.6 |
| 129 | 1 | 1.3 to 1.4 | 0.5 to 0.6 |
| 130 | 1 | 1.4 to 1.5 | 0.5 to 0.6 |
| 131 | 1 | 1.5 to 1.6 | 0.5 to 0.6 |
| 132 | 1 | 1.6 to 1.7 | 0.5 to 0.6 |
| 133 | 1 | 1.7 to 1.8 | 0.5 to 0.6 |
| 134 | 1 | 1.8 to 1.9 | 0.5 to 0.6 |
| 135 | 1 | 1.9 to 2.0 | 0.5 to 0.6 |
| 136 | 1 | 2.0 to 2.1 | 0.5 to 0.6 |
| 137 | 1 | 2.1 to 2.2 | 0.5 to 0.6 |
| 138 | 1 | 2.2 to 2.3 | 0.5 to 0.6 |
| 139 | 1 | 2.3 to 2.4 | 0.5 to 0.6 |
| 140 | 1 | 2.4 to 2.5 | 0.5 to 0.6 |
| 141 | 1 | 2.5 to 2.6 | 0.5 to 0.6 |
| 142 | 1 | 2.6 to 2.7 | 0.5 to 0.6 |
| 143 | 1 | 2.7 to 2.8 | 0.5 to 0.6 |
| 144 | 1 | 2.8 to 2.9 | 0.5 to 0.6 |
| 145 | 1 | 0.5 to 0.6 | 0.6 to 0.7 |
| 146 | 1 | 0.6 to 0.7 | 0.6 to 0.7 |
| 147 | 1 | 0.7 to 0.8 | 0.6 to 0.7 |
| 148 | 1 | 0.8 to 0.9 | 0.6 to 0.7 |
| 149 | 1 | 0.9 to 1.0 | 0.6 to 0.7 |
| 150 | 1 | 1.0 to 1.1 | 0.6 to 0.7 |
| 151 | 1 | 1.1 to 1.2 | 0.6 to 0.7 |
| 152 | 1 | 1.2 to 1.3 | 0.6 to 0.7 |
| 153 | 1 | 1.3 to 1.4 | 0.6 to 0.7 |
| 154 | 1 | 1.4 to 1.5 | 0.6 to 0.7 |
| 155 | 1 | 1.5 to 1.6 | 0.6 to 0.7 |
| 156 | 1 | 1.6 to 1.7 | 0.6 to 0.7 |
| 157 | 1 | 1.7 to 1.8 | 0.6 to 0.7 |
| 158 | 1 | 1.8 to 1.9 | 0.6 to 0.7 |
| 159 | 1 | 1.9 to 2.0 | 0.6 to 0.7 |
| 160 | 1 | 2.0 to 2.1 | 0.6 to 0.7 |
| 161 | 1 | 2.1 to 2.2 | 0.6 to 0.7 |
| 162 | 1 | 2.2 to 2.3 | 0.6 to 0.7 |
| 163 | 1 | 2.3 to 2.4 | 0.6 to 0.7 |
| 164 | 1 | 2.4 to 2.5 | 0.6 to 0.7 |
| 165 | 1 | 2.5 to 2.6 | 0.6 to 0.7 |
| 166 | 1 | 2.6 to 2.7 | 0.6 to 0.7 |
| 167 | 1 | 2.7 to 2.8 | 0.6 to 0.7 |
| 168 | 1 | 2.8 to 2.9 | 0.6 to 0.7 |
| 169 | 1 | 0.5 to 0.6 | 0.7 to 0.8 |
| 170 | 1 | 0.6 to 0.7 | 0.7 to 0.8 |
| 171 | 1 | 0.7 to 0.8 | 0.7 to 0.8 |
| 172 | 1 | 0.8 to 0.9 | 0.7 to 0.8 |
| 173 | 1 | 0.9 to 1.0 | 0.7 to 0.8 |
| 174 | 1 | 1.0 to 1.1 | 0.7 to 0.8 |
| 175 | 1 | 1.1 to 1.2 | 0.7 to 0.8 |
| 176 | 1 | 1.2 to 1.3 | 0.7 to 0.8 |
| 177 | 1 | 1.3 to 1.4 | 0.7 to 0.8 |
| 178 | 1 | 1.4 to 1.5 | 0.7 to 0.8 |
| 179 | 1 | 1.5 to 1.6 | 0.7 to 0.8 |
| 180 | 1 | 1.6 to 1.7 | 0.7 to 0.8 |
| 181 | 1 | 1.7 to 1.8 | 0.7 to 0.8 |
| 182 | 1 | 1.8 to 1.9 | 0.7 to 0.8 |
| 183 | 1 | 1.9 to 2.0 | 0.7 to 0.8 |
| 184 | 1 | 2.0 to 2.1 | 0.7 to 0.8 |
| 185 | 1 | 2.1 to 2.2 | 0.7 to 0.8 |
| 186 | 1 | 2.2 to 2.3 | 0.7 to 0.8 |
| 187 | 1 | 2.3 to 2.4 | 0.7 to 0.8 |
| 188 | 1 | 2.4 to 2.5 | 0.7 to 0.8 |
| 189 | 1 | 2.5 to 2.6 | 0.7 to 0.8 |
| 190 | 1 | 2.6 to 2.7 | 0.7 to 0.8 |
| 191 | 1 | 2.7 to 2.8 | 0.7 to 0.8 |
| 192 | 1 | 2.8 to 2.9 | 0.7 to 0.8 |
| 193 | 1 | 0.5 to 0.6 | 0.8 to 0.9 |
| 194 | 1 | 0.6 to 0.7 | 0.8 to 0.9 |
| 195 | 1 | 0.7 to 0.8 | 0.8 to 0.9 |
| 196 | 1 | 0.8 to 0.9 | 0.8 to 0.9 |
| 197 | 1 | 0.9 to 1.0 | 0.8 to 0.9 |
| 198 | 1 | 1.0 to 1.1 | 0.8 to 0.9 |
| 199 | 1 | 1.1 to 1.2 | 0.8 to 0.9 |
| 200 | 1 | 1.2 to 1.3 | 0.8 to 0.9 |
| 201 | 1 | 1.3 to 1.4 | 0.8 to 0.9 |
| 202 | 1 | 1.4 to 1.5 | 0.8 to 0.9 |
| 203 | 1 | 1.5 to 1.6 | 0.8 to 0.9 |
| 204 | 1 | 1.6 to 1.7 | 0.8 to 0.9 |
| 205 | 1 | 1.7 to 1.8 | 0.8 to 0.9 |
| 206 | 1 | 1.8 to 1.9 | 0.8 to 0.9 |
| 207 | 1 | 1.9 to 2.0 | 0.8 to 0.9 |
| 208 | 1 | 2.0 to 2.1 | 0.8 to 0.9 |
| 209 | 1 | 2.1 to 2.2 | 0.8 to 0.9 |
| 210 | 1 | 2.2 to 2.3 | 0.8 to 0.9 |
| 211 | 1 | 2.3 to 2.4 | 0.8 to 0.9 |
| 212 | 1 | 2.4 to 2.5 | 0.8 to 0.9 |
| 213 | 1 | 2.5 to 2.6 | 0.8 to 0.9 |
| 214 | 1 | 2.6 to 2.7 | 0.8 to 0.9 |
| 215 | 1 | 2.7 to 2.8 | 0.8 to 0.9 |
| 216 | 1 | 2.8 to 2.9 | 0.8 to 0.9 |
| 217 | 1 | 0.5 to 0.6 | 0.9 to 1.0 |
| 218 | 1 | 0.6 to 0.7 | 0.9 to 1.0 |
| 219 | 1 | 0.7 to 0.8 | 0.9 to 1.0 |
| 220 | 1 | 0.8 to 0.9 | 0.9 to 1.0 |
| 221 | 1 | 0.9 to 1.0 | 0.9 to 1.0 |
| 222 | 1 | 1.0 to 1.1 | 0.9 to 1.0 |
| 223 | 1 | 1.1 to 1.2 | 0.9 to 1.0 |
| 224 | 1 | 1.2 to 1.3 | 0.9 to 1.0 |
| 225 | 1 | 1.3 to 1.4 | 0.9 to 1.0 |
| 226 | 1 | 1.4 to 1.5 | 0.9 to 1.0 |
| 227 | 1 | 1.5 to 1.6 | 0.9 to 1.0 |
| 228 | 1 | 1.6 to 1.7 | 0.9 to 1.0 |
| 229 | 1 | 1.7 to 1.8 | 0.9 to 1.0 |
| 230 | 1 | 1.8 to 1.9 | 0.9 to 1.0 |
| 231 | 1 | 1.9 to 2.0 | 0.9 to 1.0 |
| 232 | 1 | 2.0 to 2.1 | 0.9 to 1.0 |
| 233 | 1 | 2.1 to 2.2 | 0.9 to 1.0 |
| 234 | 1 | 2.2 to 2.3 | 0.9 to 1.0 |
| 235 | 1 | 2.3 to 2.4 | 0.9 to 1.0 |
| 236 | 1 | 2.4 to 2.5 | 0.9 to 1.0 |
| 237 | 1 | 2.5 to 2.6 | 0.9 to 1.0 |
| 238 | 1 | 2.6 to 2.7 | 0.9 to 1.0 |
| 239 | 1 | 2.7 to 2.8 | 0.9 to 1.0 |
| 240 | 1 | 2.8 to 2.9 | 0.9 to 1.0 |
| 241 | 1 | 0.5 to 0.6 | 1.0 to 1.1 |
| 242 | 1 | 0.6 to 0.7 | 1.0 to 1.1 |
| 243 | 1 | 0.7 to 0.8 | 1.0 to 1.1 |
| 244 | 1 | 0.8 to 0.9 | 1.0 to 1.1 |
| 245 | 1 | 0.9 to 1.0 | 1.0 to 1.1 |
| 246 | 1 | 1.0 to 1.1 | 1.0 to 1.1 |
| 247 | 1 | 1.1 to 1.2 | 1.0 to 1.1 |
| 248 | 1 | 1.2 to 1.3 | 1.0 to 1.1 |
| 249 | 1 | 1.3 to 1.4 | 1.0 to 1.1 |
| 250 | 1 | 1.4 to 1.5 | 1.0 to 1.1 |
| 251 | 1 | 1.5 to 1.6 | 1.0 to 1.1 |
| 252 | 1 | 1.6 to 1.7 | 1.0 to 1.1 |
| 253 | 1 | 1.7 to 1.8 | 1.0 to 1.1 |
| 254 | 1 | 1.8 to 1.9 | 1.0 to 1.1 |
| 255 | 1 | 1.9 to 2.0 | 1.0 to 1.1 |
| 256 | 1 | 2.0 to 2.1 | 1.0 to 1.1 |
| 257 | 1 | 2.1 to 2.2 | 1.0 to 1.1 |
| 258 | 1 | 2.2 to 2.3 | 1.0 to 1.1 |
| 259 | 1 | 2.3 to 2.4 | 1.0 to 1.1 |
| 260 | 1 | 2.4 to 2.5 | 1.0 to 1.1 |
| 261 | 1 | 2.5 to 2.6 | 1.0 to 1.1 |
| 262 | 1 | 2.6 to 2.7 | 1.0 to 1.1 |
| 263 | 1 | 2.7 to 2.8 | 1.0 to 1.1 |
| 264 | 1 | 2.8 to 2.9 | 1.0 to 1.1 |
| 265 | 1 | 0.5 to 0.6 | 1.1 to 1.2 |
| 266 | 1 | 0.6 to 0.7 | 1.1 to 1.2 |
| 267 | 1 | 0.7 to 0.8 | 1.1 to 1.2 |
| 268 | 1 | 0.8 to 0.9 | 1.1 to 1.2 |
| 269 | 1 | 0.9 to 1.0 | 1.1 to 1.2 |
| 270 | 1 | 1.0 to 1.1 | 1.1 to 1.2 |
| 271 | 1 | 1.1 to 1.2 | 1.1 to 1.2 |
| 272 | 1 | 1.2 to 1.3 | 1.1 to 1.2 |
| 273 | 1 | 1.3 to 1.4 | 1.1 to 1.2 |
| 274 | 1 | 1.4 to 1.5 | 1.1 to 1.2 |
| 275 | 1 | 1.5 to 1.6 | 1.1 to 1.2 |
| 276 | 1 | 1.6 to 1.7 | 1.1 to 1.2 |
| 277 | 1 | 1.7 to 1.8 | 1.1 to 1.2 |
| 278 | 1 | 1.8 to 1.9 | 1.1 to 1.2 |
| 279 | 1 | 1.9 to 2.0 | 1.1 to 1.2 |
| 280 | 1 | 2.0 to 2.1 | 1.1 to 1.2 |
| 281 | 1 | 2.1 to 2.2 | 1.1 to 1.2 |
| 282 | 1 | 2.2 to 2.3 | 1.1 to 1.2 |
| 283 | 1 | 2.3 to 2.4 | 1.1 to 1.2 |
| 284 | 1 | 2.4 to 2.5 | 1.1 to 1.2 |
| 285 | 1 | 2.5 to 2.6 | 1.1 to 1.2 |
| 286 | 1 | 2.6 to 2.7 | 1.1 to 1.2 |
| 287 | 1 | 2.7 to 2.8 | 1.1 to 1.2 |
| 288 | 1 | 2.8 to 2.9 | 1.1 to 1.2 |
| 289 | 1 | 0.5 to 0.6 | 1.2 to 1.3 |
| 290 | 1 | 0.6 to 0.7 | 1.2 to 1.3 |
| 291 | 1 | 0.7 to 0.8 | 1.2 to 1.3 |
| 292 | 1 | 0.8 to 0.9 | 1.2 to 1.3 |
| 293 | 1 | 0.9 to 1.0 | 1.2 to 1.3 |
| 294 | 1 | 1.0 to 1.1 | 1.2 to 1.3 |
| 295 | 1 | 1.1 to 1.2 | 1.2 to 1.3 |
| 296 | 1 | 1.2 to 1.3 | 1.2 to 1.3 |
| 297 | 1 | 1.3 to 1.4 | 1.2 to 1.3 |
| 298 | 1 | 1.4 to 1.5 | 1.2 to 1.3 |
| 299 | 1 | 1.5 to 1.6 | 1.2 to 1.3 |
| 300 | 1 | 1.6 to 1.7 | 1.2 to 1.3 |
| 301 | 1 | 1.7 to 1.8 | 1.2 to 1.3 |
| 302 | 1 | 1.8 to 1.9 | 1.2 to 1.3 |
| 303 | 1 | 1.9 to 2.0 | 1.2 to 1.3 |
| 304 | 1 | 2.0 to 2.1 | 1.2 to 1.3 |
| 305 | 1 | 2.1 to 2.2 | 1.2 to 1.3 |
| 306 | 1 | 2.2 to 2.3 | 1.2 to 1.3 |
| 307 | 1 | 2.3 to 2.4 | 1.2 to 1.3 |
| 308 | 1 | 2.4 to 2.5 | 1.2 to 1.3 |
| 309 | 1 | 2.5 to 2.6 | 1.2 to 1.3 |
| 310 | 1 | 2.6 to 2.7 | 1.2 to 1.3 |
| 311 | 1 | 2.7 to 2.8 | 1.2 to 1.3 |
| 312 | 1 | 2.8 to 2.9 | 1.2 to 1.3 |
| 313 | 1 | 0.5 to 0.6 | 1.3 to 1.4 |
| 314 | 1 | 0.6 to 0.7 | 1.3 to 1.4 |
| 315 | 1 | 0.7 to 0.8 | 1.3 to 1.4 |
| 316 | 1 | 0.8 to 0.9 | 1.3 to 1.4 |
| 317 | 1 | 0.9 to 1.0 | 1.3 to 1.4 |
| 318 | 1 | 1.0 to 1.1 | 1.3 to 1.4 |
| 319 | 1 | 1.1 to 1.2 | 1.3 to 1.4 |
| 320 | 1 | 1.2 to 1.3 | 1.3 to 1.4 |
| 321 | 1 | 1.3 to 1.4 | 1.3 to 1.4 |
| 322 | 1 | 1.4 to 1.5 | 1.3 to 1.4 |
| 323 | 1 | 1.5 to 1.6 | 1.3 to 1.4 |
| 324 | 1 | 1.6 to 1.7 | 1.3 to 1.4 |
| 325 | 1 | 1.7 to 1.8 | 1.3 to 1.4 |
| 326 | 1 | 1.8 to 1.9 | 1.3 to 1.4 |
| 327 | 1 | 1.9 to 2.0 | 1.3 to 1.4 |
| 328 | 1 | 2.0 to 2.1 | 1.3 to 1.4 |
| 329 | 1 | 2.1 to 2.2 | 1.3 to 1.4 |
| 330 | 1 | 2.2 to 2.3 | 1.3 to 1.4 |
| 331 | 1 | 2.3 to 2.4 | 1.3 to 1.4 |
| 332 | 1 | 2.4 to 2.5 | 1.3 to 1.4 |
| 333 | 1 | 2.5 to 2.6 | 1.3 to 1.4 |
| 334 | 1 | 2.6 to 2.7 | 1.3 to 1.4 |
| 335 | 1 | 2.7 to 2.8 | 1.3 to 1.4 |
| 336 | 1 | 2.8 to 2.9 | 1.3 to 1.4 |
| 337 | 1 | 0.5 to 0.6 | 1.4 to 1.5 |
| 338 | 1 | 0.6 to 0.7 | 1.4 to 1.5 |
| 339 | 1 | 0.7 to 0.8 | 1.4 to 1.5 |
| 340 | 1 | 0.8 to 0.9 | 1.4 to 1.5 |
| 341 | 1 | 0.9 to 1.0 | 1.4 to 1.5 |
| 342 | 1 | 1.0 to 1.1 | 1.4 to 1.5 |
| 343 | 1 | 1.1 to 1.2 | 1.4 to 1.5 |
| 344 | 1 | 1.2 to 1.3 | 1.4 to 1.5 |
| 345 | 1 | 1.3 to 1.4 | 1.4 to 1.5 |
| 346 | 1 | 1.4 to 1.5 | 1.4 to 1.5 |
| 347 | 1 | 1.5 to 1.6 | 1.4 to 1.5 |
| 348 | 1 | 1.6 to 1.7 | 1.4 to 1.5 |
| 349 | 1 | 1.7 to 1.8 | 1.4 to 1.5 |
| 350 | 1 | 1.8 to 1.9 | 1.4 to 1.5 |
| 351 | 1 | 1.9 to 2.0 | 1.4 to 1.5 |
| 352 | 1 | 2.0 to 2.1 | 1.4 to 1.5 |
| 353 | 1 | 2.1 to 2.2 | 1.4 to 1.5 |
| 354 | 1 | 2.2 to 2.3 | 1.4 to 1.5 |
| 355 | 1 | 2.3 to 2.4 | 1.4 to 1.5 |
| 356 | 1 | 2.4 to 2.5 | 1.4 to 1.5 |
| 357 | 1 | 2.5 to 2.6 | 1.4 to 1.5 |
| 358 | 1 | 2.6 to 2.7 | 1.4 to 1.5 |
| 359 | 1 | 2.7 to 2.8 | 1.4 to 1.5 |
| 360 | 1 | 2.8 to 2.9 | 1.4 to 1.5 |
| 361 | 1 | 0.5 to 0.6 | 1.5 to 1.6 |
| 362 | 1 | 0.6 to 0.7 | 1.5 to 1.6 |
| 363 | 1 | 0.7 to 0.8 | 1.5 to 1.6 |
| 364 | 1 | 0.8 to 0.9 | 1.5 to 1.6 |
| 365 | 1 | 0.9 to 1.0 | 1.5 to 1.6 |
| 366 | 1 | 1.0 to 1.1 | 1.5 to 1.6 |
| 367 | 1 | 1.1 to 1.2 | 1.5 to 1.6 |
| 368 | 1 | 1.2 to 1.3 | 1.5 to 1.6 |
| 369 | 1 | 1.3 to 1.4 | 1.5 to 1.6 |
| 370 | 1 | 1.4 to 1.5 | 1.5 to 1.6 |
| 371 | 1 | 1.5 to 1.6 | 1.5 to 1.6 |
| 372 | 1 | 1.6 to 1.7 | 1.5 to 1.6 |
| 373 | 1 | 1.7 to 1.8 | 1.5 to 1.6 |
| 374 | 1 | 1.8 to 1.9 | 1.5 to 1.6 |
| 375 | 1 | 1.9 to 2.0 | 1.5 to 1.6 |
| 376 | 1 | 2.0 to 2.1 | 1.5 to 1.6 |
| 377 | 1 | 2.1 to 2.2 | 1.5 to 1.6 |
| 378 | 1 | 2.2 to 2.3 | 1.5 to 1.6 |
| 379 | 1 | 2.3 to 2.4 | 1.5 to 1.6 |
| 380 | 1 | 2.4 to 2.5 | 1.5 to 1.6 |
| 381 | 1 | 2.5 to 2.6 | 1.5 to 1.6 |
| 382 | 1 | 2.6 to 2.7 | 1.5 to 1.6 |
| 383 | 1 | 2.7 to 2.8 | 1.5 to 1.6 |
| 384 | 1 | 2.8 to 2.9 | 1.5 to 1.6 |
| 385 | 1 | 0.5 to 0.6 | 1.6 to 1.7 |
| 386 | 1 | 0.6 to 0.7 | 1.6 to 1.7 |
| 387 | 1 | 0.7 to 0.8 | 1.6 to 1.7 |
| 388 | 1 | 0.8 to 0.9 | 1.6 to 1.7 |
| 389 | 1 | 0.9 to 1.0 | 1.6 to 1.7 |
| 390 | 1 | 1.0 to 1.1 | 1.6 to 1.7 |
| 391 | 1 | 1.1 to 1.2 | 1.6 to 1.7 |
| 392 | 1 | 1.2 to 1.3 | 1.6 to 1.7 |
| 393 | 1 | 1.3 to 1.4 | 1.6 to 1.7 |
| 394 | 1 | 1.4 to 1.5 | 1.6 to 1.7 |
| 395 | 1 | 1.5 to 1.6 | 1.6 to 1.7 |
| 396 | 1 | 1.6 to 1.7 | 1.6 to 1.7 |
| 397 | 1 | 1.7 to 1.8 | 1.6 to 1.7 |
| 398 | 1 | 1.8 to 1.9 | 1.6 to 1.7 |
| 399 | 1 | 1.9 to 2.0 | 1.6 to 1.7 |
| 400 | 1 | 2.0 to 2.1 | 1.6 to 1.7 |
| 401 | 1 | 2.1 to 2.2 | 1.6 to 1.7 |
| 402 | 1 | 2.2 to 2.3 | 1.6 to 1.7 |
| 403 | 1 | 2.3 to 2.4 | 1.6 to 1.7 |
| 404 | 1 | 2.4 to 2.5 | 1.6 to 1.7 |
| 405 | 1 | 2.5 to 2.6 | 1.6 to 1.7 |
| 406 | 1 | 2.6 to 2.7 | 1.6 to 1.7 |
| 407 | 1 | 2.7 to 2.8 | 1.6 to 1.7 |
| 408 | 1 | 2.8 to 2.9 | 1.6 to 1.7 |
| 409 | 1 | 0.5 to 0.6 | 1.7 to 1.8 |
| 410 | 1 | 0.6 to 0.7 | 1.7 to 1.8 |
| 411 | 1 | 0.7 to 0.8 | 1.7 to 1.8 |
| 412 | 1 | 0.8 to 0.9 | 1.7 to 1.8 |
| 413 | 1 | 0.9 to 1.0 | 1.7 to 1.8 |
| 414 | 1 | 1.0 to 1.1 | 1.7 to 1.8 |
| 415 | 1 | 1.1 to 1.2 | 1.7 to 1.8 |
| 416 | 1 | 1.2 to 1.3 | 1.7 to 1.8 |
| 417 | 1 | 1.3 to 1.4 | 1.7 to 1.8 |
| 418 | 1 | 1.4 to 1.5 | 1.7 to 1.8 |
| 419 | 1 | 1.5 to 1.6 | 1.7 to 1.8 |
| 420 | 1 | 1.6 to 1.7 | 1.7 to 1.8 |
| 421 | 1 | 1.7 to 1.8 | 1.7 to 1.8 |
| 422 | 1 | 1.8 to 1.9 | 1.7 to 1.8 |
| 423 | 1 | 1.9 to 2.0 | 1.7 to 1.8 |
| 424 | 1 | 2.0 to 2.1 | 1.7 to 1.8 |
| 425 | 1 | 2.1 to 2.2 | 1.7 to 1.8 |
| 426 | 1 | 2.2 to 2.3 | 1.7 to 1.8 |
| 427 | 1 | 2.3 to 2.4 | 1.7 to 1.8 |
| 428 | 1 | 2.4 to 2.5 | 1.7 to 1.8 |
| 429 | 1 | 2.5 to 2.6 | 1.7 to 1.8 |
| 430 | 1 | 2.6 to 2.7 | 1.7 to 1.8 |
| 431 | 1 | 2.7 to 2.8 | 1.7 to 1.8 |
| 432 | 1 | 2.8 to 2.9 | 1.7 to 1.8 |
| 433 | 1 | 0.5 to 0.6 | 1.8 to 1.9 |
| 434 | 1 | 0.6 to 0.7 | 1.8 to 1.9 |
| 435 | 1 | 0.7 to 0.8 | 1.8 to 1.9 |
| 436 | 1 | 0.8 to 0.9 | 1.8 to 1.9 |
| 437 | 1 | 0.9 to 1.0 | 1.8 to 1.9 |
| 438 | 1 | 1.0 to 1.1 | 1.8 to 1.9 |
| 439 | 1 | 1.1 to 1.2 | 1.8 to 1.9 |
| 440 | 1 | 1.2 to 1.3 | 1.8 to 1.9 |
| 441 | 1 | 1.3 to 1.4 | 1.8 to 1.9 |
| 442 | 1 | 1.4 to 1.5 | 1.8 to 1.9 |
| 443 | 1 | 1.5 to 1.6 | 1.8 to 1.9 |
| 444 | 1 | 1.6 to 1.7 | 1.8 to 1.9 |
| 445 | 1 | 1.7 to 1.8 | 1.8 to 1.9 |
| 446 | 1 | 1.8 to 1.9 | 1.8 to 1.9 |
| 447 | 1 | 1.9 to 2.0 | 1.8 to 1.9 |
| 448 | 1 | 2.0 to 2.1 | 1.8 to 1.9 |
| 449 | 1 | 2.1 to 2.2 | 1.8 to 1.9 |
| 450 | 1 | 2.2 to 2.3 | 1.8 to 1.9 |
| 451 | 1 | 2.3 to 2.4 | 1.8 to 1.9 |
| 452 | 1 | 2.4 to 2.5 | 1.8 to 1.9 |
| 453 | 1 | 2.5 to 2.6 | 1.8 to 1.9 |
| 454 | 1 | 2.6 to 2.7 | 1.8 to 1.9 |
| 455 | 1 | 2.7 to 2.8 | 1.8 to 1.9 |
| 456 | 1 | 2.8 to 2.9 | 1.8 to 1.9 |
| 457 | 1 | 0.5 to 0.6 | 1.9 to 2.0 |
| 458 | 1 | 0.6 to 0.7 | 1.9 to 2.0 |
| 459 | 1 | 0.7 to 0.8 | 1.9 to 2.0 |
| 460 | 1 | 0.8 to 0.9 | 1.9 to 2.0 |
| 461 | 1 | 0.9 to 1.0 | 1.9 to 2.0 |
| 462 | 1 | 1.0 to 1.1 | 1.9 to 2.0 |
| 463 | 1 | 1.1 to 1.2 | 1.9 to 2.0 |
| 464 | 1 | 1.2 to 1.3 | 1.9 to 2.0 |
| 465 | 1 | 1.3 to 1.4 | 1.9 to 2.0 |
| 466 | 1 | 1.4 to 1.5 | 1.9 to 2.0 |
| 467 | 1 | 1.5 to 1.6 | 1.9 to 2.0 |
| 468 | 1 | 1.6 to 1.7 | 1.9 to 2.0 |
| 469 | 1 | 1.7 to 1.8 | 1.9 to 2.0 |
| 470 | 1 | 1.8 to 1.9 | 1.9 to 2.0 |
| 471 | 1 | 1.9 to 2.0 | 1.9 to 2.0 |
| 472 | 1 | 2.0 to 2.1 | 1.9 to 2.0 |
| 473 | 1 | 2.1 to 2.2 | 1.9 to 2.0 |
| 474 | 1 | 2.2 to 2.3 | 1.9 to 2.0 |
| 475 | 1 | 2.3 to 2.4 | 1.9 to 2.0 |
| 476 | 1 | 2.4 to 2.5 | 1.9 to 2.0 |
| 477 | 1 | 2.5 to 2.6 | 1.9 to 2.0 |
| 478 | 1 | 2.6 to 2.7 | 1.9 to 2.0 |
| 479 | 1 | 2.7 to 2.8 | 1.9 to 2.0 |
| 480 | 1 | 2.8 to 2.9 | 1.9 to 2.0 |
| 481 | 1 | 0.5 to 0.6 | 2.0 to 2.1 |
| 482 | 1 | 0.6 to 0.7 | 2.0 to 2.1 |
| 483 | 1 | 0.7 to 0.8 | 2.0 to 2.1 |
| 484 | 1 | 0.8 to 0.9 | 2.0 to 2.1 |
| 485 | 1 | 0.9 to 1.0 | 2.0 to 2.1 |
| 486 | 1 | 1.0 to 1.1 | 2.0 to 2.1 |
| 487 | 1 | 1.1 to 1.2 | 2.0 to 2.1 |
| 488 | 1 | 1.2 to 1.3 | 2.0 to 2.1 |
| 489 | 1 | 1.3 to 1.4 | 2.0 to 2.1 |
| 490 | 1 | 1.4 to 1.5 | 2.0 to 2.1 |
| 491 | 1 | 1.5 to 1.6 | 2.0 to 2.1 |
| 492 | 1 | 1.6 to 1.7 | 2.0 to 2.1 |
| 493 | 1 | 1.7 to 1.8 | 2.0 to 2.1 |
| 494 | 1 | 1.8 to 1.9 | 2.0 to 2.1 |
| 495 | 1 | 1.9 to 2.0 | 2.0 to 2.1 |
| 496 | 1 | 2.0 to 2.1 | 2.0 to 2.1 |
| 497 | 1 | 2.1 to 2.2 | 2.0 to 2.1 |
| 498 | 1 | 2.2 to 2.3 | 2.0 to 2.1 |
| 499 | 1 | 2.3 to 2.4 | 2.0 to 2.1 |
| 500 | 1 | 2.4 to 2.5 | 2.0 to 2.1 |
| 501 | 1 | 2.5 to 2.6 | 2.0 to 2.1 |
| 502 | 1 | 2.6 to 2.7 | 2.0 to 2.1 |
| 503 | 1 | 2.7 to 2.8 | 2.0 to 2.1 |
| 504 | 1 | 2.8 to 2.9 | 2.0 to 2.1 |
| 505 | 1 | 0.5 to 0.6 | 2.1 to 2.2 |
| 506 | 1 | 0.6 to 0.7 | 2.1 to 2.2 |
| 507 | 1 | 0.7 to 0.8 | 2.1 to 2.2 |
| 508 | 1 | 0.8 to 0.9 | 2.1 to 2.2 |
| 509 | 1 | 0.9 to 1.0 | 2.1 to 2.2 |
| 510 | 1 | 1.0 to 1.1 | 2.1 to 2.2 |
| 511 | 1 | 1.1 to 1.2 | 2.1 to 2.2 |
| 512 | 1 | 1.2 to 1.3 | 2.1 to 2.2 |
| 513 | 1 | 1.3 to 1.4 | 2.1 to 2.2 |
| 514 | 1 | 1.4 to 1.5 | 2.1 to 2.2 |
| 515 | 1 | 1.5 to 1.6 | 2.1 to 2.2 |
| 516 | 1 | 1.6 to 1.7 | 2.1 to 2.2 |
| 517 | 1 | 1.7 to 1.8 | 2.1 to 2.2 |
| 518 | 1 | 1.8 to 1.9 | 2.1 to 2.2 |
| 519 | 1 | 1.9 to 2.0 | 2.1 to 2.2 |
| 520 | 1 | 2.0 to 2.1 | 2.1 to 2.2 |
| 521 | 1 | 2.1 to 2.2 | 2.1 to 2.2 |
| 522 | 1 | 2.2 to 2.3 | 2.1 to 2.2 |
| 523 | 1 | 2.3 to 2.4 | 2.1 to 2.2 |
| 524 | 1 | 2.4 to 2.5 | 2.1 to 2.2 |
| 525 | 1 | 2.5 to 2.6 | 2.1 to 2.2 |
| 526 | 1 | 2.6 to 2.7 | 2.1 to 2.2 |
| 527 | 1 | 2.7 to 2.8 | 2.1 to 2.2 |
| 528 | 1 | 2.8 to 2.9 | 2.1 to 2.2 |
| 529 | 1 | 0.5 to 0.6 | 2.2 to 2.3 |
| 530 | 1 | 0.6 to 0.7 | 2.2 to 2.3 |
| 531 | 1 | 0.7 to 0.8 | 2.2 to 2.3 |
| 532 | 1 | 0.8 to 0.9 | 2.2 to 2.3 |
| 533 | 1 | 0.9 to 1.0 | 2.2 to 2.3 |
| 534 | 1 | 1.0 to 1.1 | 2.2 to 2.3 |
| 535 | 1 | 1.1 to 1.2 | 2.2 to 2.3 |
| 536 | 1 | 1.2 to 1.3 | 2.2 to 2.3 |
| 537 | 1 | 1.3 to 1.4 | 2.2 to 2.3 |
| 538 | 1 | 1.4 to 1.5 | 2.2 to 2.3 |
| 539 | 1 | 1.5 to 1.6 | 2.2 to 2.3 |
| 540 | 1 | 1.6 to 1.7 | 2.2 to 2.3 |
| 541 | 1 | 1.7 to 1.8 | 2.2 to 2.3 |
| 542 | 1 | 1.8 to 1.9 | 2.2 to 2.3 |
| 543 | 1 | 1.9 to 2.0 | 2.2 to 2.3 |
| 544 | 1 | 2.0 to 2.1 | 2.2 to 2.3 |
| 545 | 1 | 2.1 to 2.2 | 2.2 to 2.3 |
| 546 | 1 | 2.2 to 2.3 | 2.2 to 2.3 |
| 547 | 1 | 2.3 to 2.4 | 2.2 to 2.3 |
| 548 | 1 | 2.4 to 2.5 | 2.2 to 2.3 |
| 549 | 1 | 2.5 to 2.6 | 2.2 to 2.3 |
| 550 | 1 | 2.6 to 2.7 | 2.2 to 2.3 |
| 551 | 1 | 2.7 to 2.8 | 2.2 to 2.3 |
| 552 | 1 | 2.8 to 2.9 | 2.2 to 2.3 |
| 553 | 1 | 0.5 to 0.6 | 2.3 to 2.4 |
| 554 | 1 | 0.6 to 0.7 | 2.3 to 2.4 |
| 555 | 1 | 0.7 to 0.8 | 2.3 to 2.4 |
| 556 | 1 | 0.8 to 0.9 | 2.3 to 2.4 |
| 557 | 1 | 0.9 to 1.0 | 2.3 to 2.4 |
| 558 | 1 | 1.0 to 1.1 | 2.3 to 2.4 |
| 559 | 1 | 1.1 to 1.2 | 2.3 to 2.4 |
| 560 | 1 | 1.2 to 1.3 | 2.3 to 2.4 |
| 561 | 1 | 1.3 to 1.4 | 2.3 to 2.4 |
| 562 | 1 | 1.4 to 1.5 | 2.3 to 2.4 |
| 563 | 1 | 1.5 to 1.6 | 2.3 to 2.4 |
| 564 | 1 | 1.6 to 1.7 | 2.3 to 2.4 |
| 565 | 1 | 1.7 to 1.8 | 2.3 to 2.4 |
| 566 | 1 | 1.8 to 1.9 | 2.3 to 2.4 |
| 567 | 1 | 1.9 to 2.0 | 2.3 to 2.4 |
| 568 | 1 | 2.0 to 2.1 | 2.3 to 2.4 |
| 569 | 1 | 2.1 to 2.2 | 2.3 to 2.4 |
| 570 | 1 | 2.2 to 2.3 | 2.3 to 2.4 |
| 571 | 1 | 2.3 to 2.4 | 2.3 to 2.4 |
| 572 | 1 | 2.4 to 2.5 | 2.3 to 2.4 |
| 573 | 1 | 2.5 to 2.6 | 2.3 to 2.4 |
| 574 | 1 | 2.6 to 2.7 | 2.3 to 2.4 |
| 575 | 1 | 2.7 to 2.8 | 2.3 to 2.4 |
| 576 | 1 | 2.8 to 2.9 | 2.3 to 2.4 |
| 577 | 1 | 0.5 to 0.6 | 2.4 to 2.5 |
| 578 | 1 | 0.6 to 0.7 | 2.4 to 2.5 |
| 579 | 1 | 0.7 to 0.8 | 2.4 to 2.5 |
| 580 | 1 | 0.8 to 0.9 | 2.4 to 2.5 |
| 581 | 1 | 0.9 to 1.0 | 2.4 to 2.5 |
| 582 | 1 | 1.0 to 1.1 | 2.4 to 2.5 |
| 583 | 1 | 1.1 to 1.2 | 2.4 to 2.5 |
| 584 | 1 | 1.2 to 1.3 | 2.4 to 2.5 |
| 585 | 1 | 1.3 to 1.4 | 2.4 to 2.5 |
| 586 | 1 | 1.4 to 1.5 | 2.4 to 2.5 |
| 587 | 1 | 1.5 to 1.6 | 2.4 to 2.5 |
| 588 | 1 | 1.6 to 1.7 | 2.4 to 2.5 |
| 589 | 1 | 1.7 to 1.8 | 2.4 to 2.5 |
| 590 | 1 | 1.8 to 1.9 | 2.4 to 2.5 |
| 591 | 1 | 1.9 to 2.0 | 2.4 to 2.5 |
| 592 | 1 | 2.0 to 2.1 | 2.4 to 2.5 |
| 593 | 1 | 2.1 to 2.2 | 2.4 to 2.5 |
| 594 | 1 | 2.2 to 2.3 | 2.4 to 2.5 |
| 595 | 1 | 2.3 to 2.4 | 2.4 to 2.5 |
| 596 | 1 | 2.4 to 2.5 | 2.4 to 2.5 |
| 597 | 1 | 2.5 to 2.6 | 2.4 to 2.5 |
| 598 | 1 | 2.6 to 2.7 | 2.4 to 2.5 |
| 599 | 1 | 2.7 to 2.8 | 2.4 to 2.5 |
| 600 | 1 | 2.8 to 2.9 | 2.4 to 2.5 |
| 601 | 1 | 0.5 to 0.6 | 2.5 to 2.6 |
| 602 | 1 | 0.6 to 0.7 | 2.5 to 2.6 |
| 603 | 1 | 0.7 to 0.8 | 2.5 to 2.6 |
| 604 | 1 | 0.8 to 0.9 | 2.5 to 2.6 |
| 605 | 1 | 0.9 to 1.0 | 2.5 to 2.6 |
| 606 | 1 | 1.0 to 1.1 | 2.5 to 2.6 |
| 607 | 1 | 1.1 to 1.2 | 2.5 to 2.6 |
| 608 | 1 | 1.2 to 1.3 | 2.5 to 2.6 |
| 609 | 1 | 1.3 to 1.4 | 2.5 to 2.6 |
| 610 | 1 | 1.4 to 1.5 | 2.5 to 2.6 |
| 611 | 1 | 1.5 to 1.6 | 2.5 to 2.6 |
| 612 | 1 | 1.6 to 1.7 | 2.5 to 2.6 |
| 613 | 1 | 1.7 to 1.8 | 2.5 to 2.6 |
| 614 | 1 | 1.8 to 1.9 | 2.5 to 2.6 |
| 615 | 1 | 1.9 to 2.0 | 2.5 to 2.6 |
| 616 | 1 | 2.0 to 2.1 | 2.5 to 2.6 |
| 617 | 1 | 2.1 to 2.2 | 2.5 to 2.6 |
| 618 | 1 | 2.2 to 2.3 | 2.5 to 2.6 |
| 619 | 1 | 2.3 to 2.4 | 2.5 to 2.6 |
| 620 | 1 | 2.4 to 2.5 | 2.5 to 2.6 |
| 621 | 1 | 2.5 to 2.6 | 2.5 to 2.6 |
| 622 | 1 | 2.6 to 2.7 | 2.5 to 2.6 |
| 623 | 1 | 2.7 to 2.8 | 2.5 to 2.6 |
| 624 | 1 | 2.8 to 2.9 | 2.5 to 2.6 |
| 625 | 1 | 0.5 to 0.6 | 2.5 to 2.6 |
| 626 | 1 | 0.6 to 0.7 | 2.5 to 2.6 |
| 627 | 1 | 0.7 to 0.8 | 2.5 to 2.6 |
| 628 | 1 | 0.8 to 0.9 | 2.5 to 2.6 |
| 629 | 1 | 0.9 to 1.0 | 2.5 to 2.6 |
| 630 | 1 | 1.0 to 1.1 | 2.5 to 2.6 |
| 631 | 1 | 1.1 to 1.2 | 2.5 to 2.6 |
| 632 | 1 | 1.2 to 1.3 | 2.5 to 2.6 |
| 633 | 1 | 1.3 to 1.4 | 2.5 to 2.6 |
| 634 | 1 | 1.4 to 1.5 | 2.5 to 2.6 |
| 635 | 1 | 1.5 to 1.6 | 2.5 to 2.6 |
| 636 | 1 | 1.6 to 1.7 | 2.5 to 2.6 |
| 637 | 1 | 1.7 to 1.8 | 2.5 to 2.6 |
| 638 | 1 | 1.8 to 1.9 | 2.5 to 2.6 |
| 639 | 1 | 1.9 to 2.0 | 2.5 to 2.6 |
| 640 | 1 | 2.0 to 2.1 | 2.5 to 2.6 |
| 641 | 1 | 2.1 to 2.2 | 2.5 to 2.6 |
| 642 | 1 | 2.2 to 2.3 | 2.5 to 2.6 |
| 643 | 1 | 2.3 to 2.4 | 2.5 to 2.6 |
| 644 | 1 | 2.4 to 2.5 | 2.5 to 2.6 |
| 645 | 1 | 2.5 to 2.6 | 2.5 to 2.6 |
| 646 | 1 | 2.6 to 2.7 | 2.5 to 2.6 |
| 647 | 1 | 2.7 to 2.8 | 2.5 to 2.6 |
| 648 | 1 | 2.8 to 2.9 | 2.5 to 2.6 |
| 649 | 1 | 0.5 to 0.6 | 2.6 to 2.7 |
| 650 | 1 | 0.6 to 0.7 | 2.6 to 2.7 |
| 651 | 1 | 0.7 to 0.8 | 2.6 to 2.7 |
| 652 | 1 | 0.8 to 0.9 | 2.6 to 2.7 |
| 653 | 1 | 0.9 to 1.0 | 2.6 to 2.7 |
| 654 | 1 | 1.0 to 1.1 | 2.6 to 2.7 |
| 655 | 1 | 1.1 to 1.2 | 2.6 to 2.7 |
| 656 | 1 | 1.2 to 1.3 | 2.6 to 2.7 |
| 657 | 1 | 1.3 to 1.4 | 2.6 to 2.7 |
| 658 | 1 | 1.4 to 1.5 | 2.6 to 2.7 |
| 659 | 1 | 1.5 to 1.6 | 2.6 to 2.7 |
| 660 | 1 | 1.6 to 1.7 | 2.6 to 2.7 |
| 661 | 1 | 1.7 to 1.8 | 2.6 to 2.7 |
| 662 | 1 | 1.8 to 1.9 | 2.6 to 2.7 |
| 663 | 1 | 1.9 to 2.0 | 2.6 to 2.7 |
| 664 | 1 | 2.0 to 2.1 | 2.6 to 2.7 |
| 665 | 1 | 2.1 to 2.2 | 2.6 to 2.7 |
| 666 | 1 | 2.2 to 2.3 | 2.6 to 2.7 |
| 667 | 1 | 2.3 to 2.4 | 2.6 to 2.7 |
| 668 | 1 | 2.4 to 2.5 | 2.6 to 2.7 |
| 669 | 1 | 2.5 to 2.6 | 2.6 to 2.7 |
| 670 | 1 | 2.6 to 2.7 | 2.6 to 2.7 |
| 671 | 1 | 2.7 to 2.8 | 2.6 to 2.7 |
| 672 | 1 | 2.8 to 2.9 | 2.6 to 2.7 |
| 673 | 1 | 0.5 to 0.6 | 2.7 to 2.8 |
| 674 | 1 | 0.6 to 0.7 | 2.7 to 2.8 |
| 675 | 1 | 0.7 to 0.8 | 2.7 to 2.8 |
| 676 | 1 | 0.8 to 0.9 | 2.7 to 2.8 |
| 677 | 1 | 0.9 to 1.0 | 2.7 to 2.8 |
| 678 | 1 | 1.0 to 1.1 | 2.7 to 2.8 |
| 679 | 1 | 1.1 to 1.2 | 2.7 to 2.8 |
| 680 | 1 | 1.2 to 1.3 | 2.7 to 2.8 |
| 681 | 1 | 1.3 to 1.4 | 2.7 to 2.8 |
| 682 | 1 | 1.4 to 1.5 | 2.7 to 2.8 |
| 683 | 1 | 1.5 to 1.6 | 2.7 to 2.8 |
| 684 | 1 | 1.6 to 1.7 | 2.7 to 2.8 |
| 685 | 1 | 1.7 to 1.8 | 2.7 to 2.8 |
| 686 | 1 | 1.8 to 1.9 | 2.7 to 2.8 |
| 687 | 1 | 1.9 to 2.0 | 2.7 to 2.8 |
| 688 | 1 | 2.0 to 2.1 | 2.7 to 2.8 |
| 689 | 1 | 2.1 to 2.2 | 2.7 to 2.8 |
| 690 | 1 | 2.2 to 2.3 | 2.7 to 2.8 |
| 691 | 1 | 2.3 to 2.4 | 2.7 to 2.8 |
| 692 | 1 | 2.4 to 2.5 | 2.7 to 2.8 |
| 693 | 1 | 2.5 to 2.6 | 2.7 to 2.8 |
| 694 | 1 | 2.6 to 2.7 | 2.7 to 2.8 |
| 695 | 1 | 2.7 to 2.8 | 2.7 to 2.8 |
| 696 | 1 | 2.8 to 2.9 | 2.7 to 2.8 |
| 697 | 1 | 0.5 to 0.6 | 2.8 to 2.9 |
| 698 | 1 | 0.6 to 0.7 | 2.8 to 2.9 |
| 699 | 1 | 0.7 to 0.8 | 2.8 to 2.9 |
| 700 | 1 | 0.8 to 0.9 | 2.8 to 2.9 |
| 701 | 1 | 0.9 to 1.0 | 2.8 to 2.9 |
| 702 | 1 | 1.0 to 1.1 | 2.8 to 2.9 |
| 703 | 1 | 1.1 to 1.2 | 2.8 to 2.9 |
| 704 | 1 | 1.2 to 1.3 | 2.8 to 2.9 |
| 705 | 1 | 1.3 to 1.4 | 2.8 to 2.9 |
| 706 | 1 | 1.4 to 1.5 | 2.8 to 2.9 |
| 707 | 1 | 1.5 to 1.6 | 2.8 to 2.9 |
| 708 | 1 | 1.6 to 1.7 | 2.8 to 2.9 |
| 709 | 1 | 1.7 to 1.8 | 2.8 to 2.9 |
| 710 | 1 | 1.8 to 1.9 | 2.8 to 2.9 |
| 711 | 1 | 1.9 to 2.0 | 2.8 to 2.9 |
| 712 | 1 | 2.0 to 2.1 | 2.8 to 2.9 |
| 713 | 1 | 2.1 to 2.2 | 2.8 to 2.9 |
| 714 | 1 | 2.2 to 2.3 | 2.8 to 2.9 |
| 715 | 1 | 2.3 to 2.4 | 2.8 to 2.9 |
| 716 | 1 | 2.4 to 2.5 | 2.8 to 2.9 |
| 717 | 1 | 2.5 to 2.6 | 2.8 to 2.9 |
| 718 | 1 | 2.6 to 2.7 | 2.8 to 2.9 |
| 719 | 1 | 2.7 to 2.8 | 2.8 to 2.9 |
| 720 | 1 | 2.8 to 2.9 | 2.8 to 2.9 |
| 721 | 1 | 0.5 to 0.6 | 2.9 to 3.0 |
| 722 | 1 | 0.6 to 0.7 | 2.9 to 3.0 |
| 723 | 1 | 0.7 to 0.8 | 2.9 to 3.0 |
| 724 | 1 | 0.8 to 0.9 | 2.9 to 3.0 |
| 725 | 1 | 0.9 to 1.0 | 2.9 to 3.0 |
| 726 | 1 | 1.0 to 1.1 | 2.9 to 3.0 |
| 727 | 1 | 1.1 to 1.2 | 2.9 to 3.0 |
| 728 | 1 | 1.2 to 1.3 | 2.9 to 3.0 |
| 729 | 1 | 1.3 to 1.4 | 2.9 to 3.0 |
| 730 | 1 | 1.4 to 1.5 | 2.9 to 3.0 |
| 731 | 1 | 1.5 to 1.6 | 2.9 to 3.0 |
| 732 | 1 | 1.6 to 1.7 | 2.9 to 3.0 |
| 733 | 1 | 1.7 to 1.8 | 2.9 to 3.0 |
| 734 | 1 | 1.8 to 1.9 | 2.9 to 3.0 |
| 735 | 1 | 1.9 to 2.0 | 2.9 to 3.0 |
| 736 | 1 | 2.0 to 2.1 | 2.9 to 3.0 |
| 737 | 1 | 2.1 to 2.2 | 2.9 to 3.0 |
| 738 | 1 | 2.2 to 2.3 | 2.9 to 3.0 |
| 739 | 1 | 2.3 to 2.4 | 2.9 to 3.0 |
| 740 | 1 | 2.4 to 2.5 | 2.9 to 3.0 |
| 741 | 1 | 2.5 to 2.6 | 2.9 to 3.0 |
| 742 | 1 | 2.6 to 2.7 | 2.9 to 3.0 |
| 743 | 1 | 2.7 to 2.8 | 2.9 to 3.0 |
| 744 | 1 | 2.8 to 2.9 | 2.9 to 3.0 |
| SPECIES | Si | N | C |
| 745 | 1 | 0.5 to 0.6 | 0 to 0.1 |
| 746 | 1 | 0.6 to 0.7 | 0 to 0.1 |
| 747 | 1 | 0.7 to 0.8 | 0 to 0.1 |
| 748 | 1 | 0.8 to 0.9 | 0 to 0.1 |
| 749 | 1 | 0.9 to 1.0 | 0 to 0.1 |
| 750 | 1 | 1.0 to 1.1 | 0 to 0.1 |
| 751 | 1 | 1.1 to 1.2 | 0 to 0.1 |
| 752 | 1 | 1.2 to 1.3 | 0 to 0.1 |
| 753 | 1 | 1.3 to 1.4 | 0 to 0.1 |
| 754 | 1 | 1.4 to 1.5 | 0 to 0.1 |
| 755 | 1 | 1.5 to 1.6 | 0 to 0.1 |
| 756 | 1 | 1.6 to 1.7 | 0 to 0.1 |
| 757 | 1 | 1.7 to 1.8 | 0 to 0.1 |
| 758 | 1 | 1.8 to 1.9 | 0 to 0.1 |
| 759 | 1 | 1.9 to 2.0 | 0 to 0.1 |
| 760 | 1 | 2.0 to 2.1 | 0 to 0.1 |
| 761 | 1 | 2.1 to 2.2 | 0 to 0.1 |
| 762 | 1 | 2.2 to 2.3 | 0 to 0.1 |
| 763 | 1 | 2.3 to 2.4 | 0 to 0.1 |
| 764 | 1 | 2.4 to 2.5 | 0 to 0.1 |
| 765 | 1 | 2.5 to 2.6 | 0 to 0.1 |
| 766 | 1 | 2.6 to 2.7 | 0 to 0.1 |
| 767 | 1 | 2.7 to 2.8 | 0 to 0.1 |
| 768 | 1 | 2.8 to 2.9 | 0 to 0.1 |
| 769 | 1 | 0.5 to 0.6 | 0.1 to 0.2 |
| 770 | 1 | 0.6 to 0.7 | 0.1 to 0.2 |
| 771 | 1 | 0.7 to 0.8 | 0.1 to 0.2 |
| 772 | 1 | 0.8 to 0.9 | 0.1 to 0.2 |
| 773 | 1 | 0.9 to 1.0 | 0.1 to 0.2 |
| 774 | 1 | 1.0 to 1.1 | 0.1 to 0.2 |
| 775 | 1 | 1.1 to 1.2 | 0.1 to 0.2 |
| 776 | 1 | 1.2 to 1.3 | 0.1 to 0.2 |
| 777 | 1 | 1.3 to 1.4 | 0.1 to 0.2 |
| 778 | 1 | 1.4 to 1.5 | 0.1 to 0.2 |
| 779 | 1 | 1.5 to 1.6 | 0.1 to 0.2 |
| 780 | 1 | 1.6 to 1.7 | 0.1 to 0.2 |
| 781 | 1 | 1.7 to 1.8 | 0.1 to 0.2 |
| 782 | 1 | 1.8 to 1.9 | 0.1 to 0.2 |
| 783 | 1 | 1.9 to 2.0 | 0.1 to 0.2 |
| 784 | 1 | 2.0 to 2.1 | 0.1 to 0.2 |
| 785 | 1 | 2.1 to 2.2 | 0.1 to 0.2 |
| 786 | 1 | 2.2 to 2.3 | 0.1 to 0.2 |
| 787 | 1 | 2.3 to 2.4 | 0.1 to 0.2 |
| 788 | 1 | 2.4 to 2.5 | 0.1 to 0.2 |
| 789 | 1 | 2.5 to 2.6 | 0.1 to 0.2 |
| 790 | 1 | 2.6 to 2.7 | 0.1 to 0.2 |
| 791 | 1 | 2.7 to 2.8 | 0.1 to 0.2 |
| 792 | 1 | 2.8 to 2.9 | 0.1 to 0.2 |
| 793 | 1 | 0.5 to 0.6 | 0.2 to 0.3 |
| 794 | 1 | 0.6 to 0.7 | 0.2 to 0.3 |
| 795 | 1 | 0.7 to 0.8 | 0.2 to 0.3 |
| 796 | 1 | 0.8 to 0.9 | 0.2 to 0.3 |
| 797 | 1 | 0.9 to 1.0 | 0.2 to 0.3 |
| 798 | 1 | 1.0 to 1.1 | 0.2 to 0.3 |
| 799 | 1 | 1.1 to 1.2 | 0.2 to 0.3 |
| 800 | 1 | 1.2 to 1.3 | 0.2 to 0.3 |
| 801 | 1 | 1.3 to 1.4 | 0.2 to 0.3 |
| 802 | 1 | 1.4 to 1.5 | 0.2 to 0.3 |
| 803 | 1 | 1.5 to 1.6 | 0.2 to 0.3 |
| 804 | 1 | 1.6 to 1.7 | 0.2 to 0.3 |
| 805 | 1 | 1.7 to 1.8 | 0.2 to 0.3 |
| 806 | 1 | 1.8 to 1.9 | 0.2 to 0.3 |
| 807 | 1 | 1.9 to 2.0 | 0.2 to 0.3 |
| 808 | 1 | 2.0 to 2.1 | 0.2 to 0.3 |
| 809 | 1 | 2.1 to 2.2 | 0.2 to 0.3 |
| 810 | 1 | 2.2 to 2.3 | 0.2 to 0.3 |
| 811 | 1 | 2.3 to 2.4 | 0.2 to 0.3 |
| 812 | 1 | 2.4 to 2.5 | 0.2 to 0.3 |
| 813 | 1 | 2.5 to 2.6 | 0.2 to 0.3 |
| 814 | 1 | 2.6 to 2.7 | 0.2 to 0.3 |
| 815 | 1 | 2.7 to 2.8 | 0.2 to 0.3 |
| 816 | 1 | 2.8 to 2.9 | 0.2 to 0.3 |
| 817 | 1 | 0.5 to 0.6 | 0.3 to 0.4 |
| 818 | 1 | 0.6 to 0.7 | 0.3 to 0.4 |
| 819 | 1 | 0.7 to 0.8 | 0.3 to 0.4 |
| 820 | 1 | 0.8 to 0.9 | 0.3 to 0.4 |
| 821 | 1 | 0.9 to 1.0 | 0.3 to 0.4 |
| 822 | 1 | 1.0 to 1.1 | 0.3 to 0.4 |
| 823 | 1 | 1.1 to 1.2 | 0.3 to 0.4 |
| 824 | 1 | 1.2 to 1.3 | 0.3 to 0.4 |
| 825 | 1 | 1.3 to 1.4 | 0.3 to 0.4 |
| 826 | 1 | 1.4 to 1.5 | 0.3 to 0.4 |
| 827 | 1 | 1.5 to 1.6 | 0.3 to 0.4 |
| 828 | 1 | 1.6 to 1.7 | 0.3 to 0.4 |
| 829 | 1 | 1.7 to 1.8 | 0.3 to 0.4 |
| 830 | 1 | 1.8 to 1.9 | 0.3 to 0.4 |
| 831 | 1 | 1.9 to 2.0 | 0.3 to 0.4 |
| 832 | 1 | 2.0 to 2.1 | 0.3 to 0.4 |
| 833 | 1 | 2.1 to 2.2 | 0.3 to 0.4 |
| 834 | 1 | 2.2 to 2.3 | 0.3 to 0.4 |
| 835 | 1 | 2.3 to 2.4 | 0.3 to 0.4 |
| 836 | 1 | 2.4 to 2.5 | 0.3 to 0.4 |
| 837 | 1 | 2.5 to 2.6 | 0.3 to 0.4 |
| 838 | 1 | 2.6 to 2.7 | 0.3 to 0.4 |
| 839 | 1 | 2.7 to 2.8 | 0.3 to 0.4 |
| 840 | 1 | 2.8 to 2.9 | 0.3 to 0.4 |
| 841 | 1 | 0.5 to 0.6 | 0.4 to 0.5 |
| 842 | 1 | 0.6 to 0.7 | 0.4 to 0.5 |
| 843 | 1 | 0.7 to 0.8 | 0.4 to 0.5 |
| 844 | 1 | 0.8 to 0.9 | 0.4 to 0.5 |
| 845 | 1 | 0.9 to 1.0 | 0.4 to 0.5 |
| 846 | 1 | 1.0 to 1.1 | 0.4 to 0.5 |
| 847 | 1 | 1.1 to 1.2 | 0.4 to 0.5 |
| 848 | 1 | 1.2 to 1.3 | 0.4 to 0.5 |
| 849 | 1 | 1.3 to 1.4 | 0.4 to 0.5 |
| 850 | 1 | 1.4 to 1.5 | 0.4 to 0.5 |
| 851 | 1 | 1.5 to 1.6 | 0.4 to 0.5 |
| 852 | 1 | 1.6 to 1.7 | 0.4 to 0.5 |
| 853 | 1 | 1.7 to 1.8 | 0.4 to 0.5 |
| 854 | 1 | 1.8 to 1.9 | 0.4 to 0.5 |
| 855 | 1 | 1.9 to 2.0 | 0.4 to 0.5 |
| 856 | 1 | 2.0 to 2.1 | 0.4 to 0.5 |
| 857 | 1 | 2.1 to 2.2 | 0.4 to 0.5 |
| 858 | 1 | 2.2 to 2.3 | 0.4 to 0.5 |
| 859 | 1 | 2.3 to 2.4 | 0.4 to 0.5 |
| 860 | 1 | 2.4 to 2.5 | 0.4 to 0.5 |
| 861 | 1 | 2.5 to 2.6 | 0.4 to 0.5 |
| 862 | 1 | 2.6 to 2.7 | 0.4 to 0.5 |
| 863 | 1 | 2.7 to 2.8 | 0.4 to 0.5 |
| 864 | 1 | 2.8 to 2.9 | 0.4 to 0.5 |
| 865 | 1 | 0.5 to 0.6 | 0.5 to 0.6 |
| 866 | 1 | 0.6 to 0.7 | 0.5 to 0.6 |
| 867 | 1 | 0.7 to 0.8 | 0.5 to 0.6 |
| 868 | 1 | 0.8 to 0.9 | 0.5 to 0.6 |
| 869 | 1 | 0.9 to 1.0 | 0.5 to 0.6 |
| 870 | 1 | 1.0 to 1.1 | 0.5 to 0.6 |
| 871 | 1 | 1.1 to 1.2 | 0.5 to 0.6 |
| 872 | 1 | 1.2 to 1.3 | 0.5 to 0.6 |
| 873 | 1 | 1.3 to 1.4 | 0.5 to 0.6 |
| 874 | 1 | 1.4 to 1.5 | 0.5 to 0.6 |
| 875 | 1 | 1.5 to 1.6 | 0.5 to 0.6 |
| 876 | 1 | 1.6 to 1.7 | 0.5 to 0.6 |
| 877 | 1 | 1.7 to 1.8 | 0.5 to 0.6 |
| 878 | 1 | 1.8 to 1.9 | 0.5 to 0.6 |
| 879 | 1 | 1.9 to 2.0 | 0.5 to 0.6 |
| 880 | 1 | 2.0 to 2.1 | 0.5 to 0.6 |
| 881 | 1 | 2.1 to 2.2 | 0.5 to 0.6 |
| 882 | 1 | 2.2 to 2.3 | 0.5 to 0.6 |
| 883 | 1 | 2.3 to 2.4 | 0.5 to 0.6 |
| 884 | 1 | 2.4 to 2.5 | 0.5 to 0.6 |
| 885 | 1 | 2.5 to 2.6 | 0.5 to 0.6 |
| 886 | 1 | 2.6 to 2.7 | 0.5 to 0.6 |
| 887 | 1 | 2.7 to 2.8 | 0.5 to 0.6 |
| 888 | 1 | 2.8 to 2.9 | 0.5 to 0.6 |
| 889 | 1 | 0.5 to 0.6 | 0.6 to 0.7 |
| 890 | 1 | 0.6 to 0.7 | 0.6 to 0.7 |
| 891 | 1 | 0.7 to 0.8 | 0.6 to 0.7 |
| 892 | 1 | 0.8 to 0.9 | 0.6 to 0.7 |
| 893 | 1 | 0.9 to 1.0 | 0.6 to 0.7 |
| 894 | 1 | 1.0 to 1.1 | 0.6 to 0.7 |
| 895 | 1 | 1.1 to 1.2 | 0.6 to 0.7 |
| 896 | 1 | 1.2 to 1.3 | 0.6 to 0.7 |
| 897 | 1 | 1.3 to 1.4 | 0.6 to 0.7 |
| 898 | 1 | 1.4 to 1.5 | 0.6 to 0.7 |
| 899 | 1 | 1.5 to 1.6 | 0.6 to 0.7 |
| 900 | 1 | 1.6 to 1.7 | 0.6 to 0.7 |
| 901 | 1 | 1.7 to 1.8 | 0.6 to 0.7 |
| 902 | 1 | 1.8 to 1.9 | 0.6 to 0.7 |
| 903 | 1 | 1.9 to 2.0 | 0.6 to 0.7 |
| 904 | 1 | 2.0 to 2.1 | 0.6 to 0.7 |
| 905 | 1 | 2.1 to 2.2 | 0.6 to 0.7 |
| 906 | 1 | 2.2 to 2.3 | 0.6 to 0.7 |
| 907 | 1 | 2.3 to 2.4 | 0.6 to 0.7 |
| 908 | 1 | 2.4 to 2.5 | 0.6 to 0.7 |
| 909 | 1 | 2.5 to 2.6 | 0.6 to 0.7 |
| 910 | 1 | 2.6 to 2.7 | 0.6 to 0.7 |
| 911 | 1 | 2.7 to 2.8 | 0.6 to 0.7 |
| 912 | 1 | 2.8 to 2.9 | 0.6 to 0.7 |
| 913 | 1 | 0.5 to 0.6 | 0.7 to 0.8 |
| 914 | 1 | 0.6 to 0.7 | 0.7 to 0.8 |
| 915 | 1 | 0.7 to 0.8 | 0.7 to 0.8 |
| 916 | 1 | 0.8 to 0.9 | 0.7 to 0.8 |
| 917 | 1 | 0.9 to 1.0 | 0.7 to 0.8 |
| 918 | 1 | 1.0 to 1.1 | 0.7 to 0.8 |
| 919 | 1 | 1.1 to 1.2 | 0.7 to 0.8 |
| 920 | 1 | 1.2 to 1.3 | 0.7 to 0.8 |
| 921 | 1 | 1.3 to 1.4 | 0.7 to 0.8 |
| 922 | 1 | 1.4 to 1.5 | 0.7 to 0.8 |
| 923 | 1 | 1.5 to 1.6 | 0.7 to 0.8 |
| 924 | 1 | 1.6 to 1.7 | 0.7 to 0.8 |
| 925 | 1 | 1.7 to 1.8 | 0.7 to 0.8 |
| 926 | 1 | 1.8 to 1.9 | 0.7 to 0.8 |
| 927 | 1 | 1.9 to 2.0 | 0.7 to 0.8 |
| 928 | 1 | 2.0 to 2.1 | 0.7 to 0.8 |
| 929 | 1 | 2.1 to 2.2 | 0.7 to 0.8 |
| 930 | 1 | 2.2 to 2.3 | 0.7 to 0.8 |
| 931 | 1 | 2.3 to 2.4 | 0.7 to 0.8 |
| 932 | 1 | 2.4 to 2.5 | 0.7 to 0.8 |
| 933 | 1 | 2.5 to 2.6 | 0.7 to 0.8 |
| 934 | 1 | 2.6 to 2.7 | 0.7 to 0.8 |
| 935 | 1 | 2.7 to 2.8 | 0.7 to 0.8 |
| 936 | 1 | 2.8 to 2.9 | 0.7 to 0.8 |
| 937 | 1 | 0.5 to 0.6 | 0.8 to 0.9 |
| 938 | 1 | 0.6 to 0.7 | 0.8 to 0.9 |
| 939 | 1 | 0.7 to 0.8 | 0.8 to 0.9 |
| 940 | 1 | 0.8 to 0.9 | 0.8 to 0.9 |
| 941 | 1 | 0.9 to 1.0 | 0.8 to 0.9 |
| 942 | 1 | 1.0 to 1.1 | 0.8 to 0.9 |
| 943 | 1 | 1.1 to 1.2 | 0.8 to 0.9 |
| 944 | 1 | 1.2 to 1.3 | 0.8 to 0.9 |
| 945 | 1 | 1.3 to 1.4 | 0.8 to 0.9 |
| 946 | 1 | 1.4 to 1.5 | 0.8 to 0.9 |
| 947 | 1 | 1.5 to 1.6 | 0.8 to 0.9 |
| 948 | 1 | 1.6 to 1.7 | 0.8 to 0.9 |
| 949 | 1 | 1.7 to 1.8 | 0.8 to 0.9 |
| 950 | 1 | 1.8 to 1.9 | 0.8 to 0.9 |
| 951 | 1 | 1.9 to 2.0 | 0.8 to 0.9 |
| 952 | 1 | 2.0 to 2.1 | 0.8 to 0.9 |
| 953 | 1 | 2.1 to 2.2 | 0.8 to 0.9 |
| 954 | 1 | 2.2 to 2.3 | 0.8 to 0.9 |
| 955 | 1 | 2.3 to 2.4 | 0.8 to 0.9 |
| 956 | 1 | 2.4 to 2.5 | 0.8 to 0.9 |
| 957 | 1 | 2.5 to 2.6 | 0.8 to 0.9 |
| 958 | 1 | 2.6 to 2.7 | 0.8 to 0.9 |
| 959 | 1 | 2.7 to 2.8 | 0.8 to 0.9 |
| 960 | 1 | 2.8 to 2.9 | 0.8 to 0.9 |
| 961 | 1 | 0.5 to 0.6 | 0.9 to 1.0 |
| 962 | 1 | 0.6 to 0.7 | 0.9 to 1.0 |
| 963 | 1 | 0.7 to 0.8 | 0.9 to 1.0 |
| 964 | 1 | 0.8 to 0.9 | 0.9 to 1.0 |
| 965 | 1 | 0.9 to 1.0 | 0.9 to 1.0 |
| 966 | 1 | 1.0 to 1.1 | 0.9 to 1.0 |
| 967 | 1 | 1.1 to 1.2 | 0.9 to 1.0 |
| 968 | 1 | 1.2 to 1.3 | 0.9 to 1.0 |
| 969 | 1 | 1.3 to 1.4 | 0.9 to 1.0 |
| 970 | 1 | 1.4 to 1.5 | 0.9 to 1.0 |
| 971 | 1 | 1.5 to 1.6 | 0.9 to 1.0 |
| 972 | 1 | 1.6 to 1.7 | 0.9 to 1.0 |
| 973 | 1 | 1.7 to 1.8 | 0.9 to 1.0 |
| 974 | 1 | 1.8 to 1.9 | 0.9 to 1.0 |
| 975 | 1 | 1.9 to 2.0 | 0.9 to 1.0 |
| 976 | 1 | 2.0 to 2.1 | 0.9 to 1.0 |
| 977 | 1 | 2.1 to 2.2 | 0.9 to 1.0 |
| 978 | 1 | 2.2 to 2.3 | 0.9 to 1.0 |
| 979 | 1 | 2.3 to 2.4 | 0.9 to 1.0 |
| 980 | 1 | 2.4 to 2.5 | 0.9 to 1.0 |
| 981 | 1 | 2.5 to 2.6 | 0.9 to 1.0 |
| 982 | 1 | 2.6 to 2.7 | 0.9 to 1.0 |
| 983 | 1 | 2.7 to 2.8 | 0.9 to 1.0 |
| 984 | 1 | 2.8 to 2.9 | 0.9 to 1.0 |
| 985 | 1 | 0.5 to 0.6 | 1.0 to 1.1 |
| 986 | 1 | 0.6 to 0.7 | 1.0 to 1.1 |
| 987 | 1 | 0.7 to 0.8 | 1.0 to 1.1 |
| 988 | 1 | 0.8 to 0.9 | 1.0 to 1.1 |
| 989 | 1 | 0.9 to 1.0 | 1.0 to 1.1 |
| 990 | 1 | 1.0 to 1.1 | 1.0 to 1.1 |
| 991 | 1 | 1.1 to 1.2 | 1.0 to 1.1 |
| 992 | 1 | 1.2 to 1.3 | 1.0 to 1.1 |
| 993 | 1 | 1.3 to 1.4 | 1.0 to 1.1 |
| 994 | 1 | 1.4 to 1.5 | 1.0 to 1.1 |
| 995 | 1 | 1.5 to 1.6 | 1.0 to 1.1 |
| 996 | 1 | 1.6 to 1.7 | 1.0 to 1.1 |
| 997 | 1 | 1.7 to 1.8 | 1.0 to 1.1 |
| 998 | 1 | 1.8 to 1.9 | 1.0 to 1.1 |
| 999 | 1 | 1.9 to 2.0 | 1.0 to 1.1 |
| 1000 | 1 | 2.0 to 2.1 | 1.0 to 1.1 |
| 1001 | 1 | 2.1 to 2.2 | 1.0 to 1.1 |
| 1002 | 1 | 2.2 to 2.3 | 1.0 to 1.1 |
| 1003 | 1 | 2.3 to 2.4 | 1.0 to 1.1 |
| 1004 | 1 | 2.4 to 2.5 | 1.0 to 1.1 |
| 1005 | 1 | 2.5 to 2.6 | 1.0 to 1.1 |
| 1006 | 1 | 2.6 to 2.7 | 1.0 to 1.1 |
| 1007 | 1 | 2.7 to 2.8 | 1.0 to 1.1 |
| 1008 | 1 | 2.8 to 2.9 | 1.0 to 1.1 |
| 1009 | 1 | 0.5 to 0.6 | 1.1 to 1.2 |
| 1010 | 1 | 0.6 to 0.7 | 1.1 to 1.2 |
| 1011 | 1 | 0.7 to 0.8 | 1.1 to 1.2 |
| 1012 | 1 | 0.8 to 0.9 | 1.1 to 1.2 |
| 1013 | 1 | 0.9 to 1.0 | 1.1 to 1.2 |
| 1014 | 1 | 1.0 to 1.1 | 1.1 to 1.2 |
| 1015 | 1 | 1.1 to 1.2 | 1.1 to 1.2 |
| 1016 | 1 | 1.2 to 1.3 | 1.1 to 1.2 |
| 1017 | 1 | 1.3 to 1.4 | 1.1 to 1.2 |
| 1018 | 1 | 1.4 to 1.5 | 1.1 to 1.2 |
| 1019 | 1 | 1.5 to 1.6 | 1.1 to 1.2 |
| 1020 | 1 | 1.6 to 1.7 | 1.1 to 1.2 |
| 1021 | 1 | 1.7 to 1.8 | 1.1 to 1.2 |
| 1022 | 1 | 1.8 to 1.9 | 1.1 to 1.2 |
| 1023 | 1 | 1.9 to 2.0 | 1.1 to 1.2 |
| 1024 | 1 | 2.0 to 2.1 | 1.1 to 1.2 |
| 1025 | 1 | 2.1 to 2.2 | 1.1 to 1.2 |
| 1026 | 1 | 2.2 to 2.3 | 1.1 to 1.2 |
| 1027 | 1 | 2.3 to 2.4 | 1.1 to 1.2 |
| 1028 | 1 | 2.4 to 2.5 | 1.1 to 1.2 |
| 1029 | 1 | 2.5 to 2.6 | 1.1 to 1.2 |
| 1030 | 1 | 2.6 to 2.7 | 1.1 to 1.2 |
| 1031 | 1 | 2.7 to 2.8 | 1.1 to 1.2 |
| 1032 | 1 | 2.8 to 2.9 | 1.1 to 1.2 |
| 1033 | 1 | 0.5 to 0.6 | 1.2 to 1.3 |
| 1034 | 1 | 0.6 to 0.7 | 1.2 to 1.3 |
| 1035 | 1 | 0.7 to 0.8 | 1.2 to 1.3 |
| 1036 | 1 | 0.8 to 0.9 | 1.2 to 1.3 |
| 1037 | 1 | 0.9 to 1.0 | 1.2 to 1.3 |
| 1038 | 1 | 1.0 to 1.1 | 1.2 to 1.3 |
| 1039 | 1 | 1.1 to 1.2 | 1.2 to 1.3 |
| 1040 | 1 | 1.2 to 1.3 | 1.2 to 1.3 |
| 1041 | 1 | 1.3 to 1.4 | 1.2 to 1.3 |
| 1042 | 1 | 1.4 to 1.5 | 1.2 to 1.3 |
| 1043 | 1 | 1.5 to 1.6 | 1.2 to 1.3 |
| 1044 | 1 | 1.6 to 1.7 | 1.2 to 1.3 |
| 1045 | 1 | 1.7 to 1.8 | 1.2 to 1.3 |
| 1046 | 1 | 1.8 to 1.9 | 1.2 to 1.3 |
| 1047 | 1 | 1.9 to 2.0 | 1.2 to 1.3 |
| 1048 | 1 | 2.0 to 2.1 | 1.2 to 1.3 |
| 1049 | 1 | 2.1 to 2.2 | 1.2 to 1.3 |
| 1050 | 1 | 2.2 to 2.3 | 1.2 to 1.3 |
| 1051 | 1 | 2.3 to 2.4 | 1.2 to 1.3 |
| 1052 | 1 | 2.4 to 2.5 | 1.2 to 1.3 |
| 1053 | 1 | 2.5 to 2.6 | 1.2 to 1.3 |
| 1054 | 1 | 2.6 to 2.7 | 1.2 to 1.3 |
| 1055 | 1 | 2.7 to 2.8 | 1.2 to 1.3 |
| 1056 | 1 | 2.8 to 2.9 | 1.2 to 1.3 |
| 1057 | 1 | 0.5 to 0.6 | 1.3 to 1.4 |
| 1058 | 1 | 0.6 to 0.7 | 1.3 to 1.4 |
| 1059 | 1 | 0.7 to 0.8 | 1.3 to 1.4 |
| 1060 | 1 | 0.8 to 0.9 | 1.3 to 1.4 |
| 1061 | 1 | 0.9 to 1.0 | 1.3 to 1.4 |
| 1062 | 1 | 1.0 to 1.1 | 1.3 to 1.4 |
| 1063 | 1 | 1.1 to 1.2 | 1.3 to 1.4 |
| 1064 | 1 | 1.2 to 1.3 | 1.3 to 1.4 |
| 1065 | 1 | 1.3 to 1.4 | 1.3 to 1.4 |
| 1066 | 1 | 1.4 to 1.5 | 1.3 to 1.4 |
| 1067 | 1 | 1.5 to 1.6 | 1.3 to 1.4 |
| 1068 | 1 | 1.6 to 1.7 | 1.3 to 1.4 |
| 1069 | 1 | 1.7 to 1.8 | 1.3 to 1.4 |
| 1070 | 1 | 1.8 to 1.9 | 1.3 to 1.4 |
| 1071 | 1 | 1.9 to 2.0 | 1.3 to 1.4 |
| 1072 | 1 | 2.0 to 2.1 | 1.3 to 1.4 |
| 1073 | 1 | 2.1 to 2.2 | 1.3 to 1.4 |
| 1074 | 1 | 2.2 to 2.3 | 1.3 to 1.4 |
| 1075 | 1 | 2.3 to 2.4 | 1.3 to 1.4 |
| 1076 | 1 | 2.4 to 2.5 | 1.3 to 1.4 |
| 1077 | 1 | 2.5 to 2.6 | 1.3 to 1.4 |
| 1078 | 1 | 2.6 to 2.7 | 1.3 to 1.4 |
| 1079 | 1 | 2.7 to 2.8 | 1.3 to 1.4 |
| 1080 | 1 | 2.8 to 2.9 | 1.3 to 1.4 |
| 1081 | 1 | 0.5 to 0.6 | 1.4 to 1.5 |
| 1082 | 1 | 0.6 to 0.7 | 1.4 to 1.5 |
| 1083 | 1 | 0.7 to 0.8 | 1.4 to 1.5 |
| 1084 | 1 | 0.8 to 0.9 | 1.4 to 1.5 |
| 1085 | 1 | 0.9 to 1.0 | 1.4 to 1.5 |
| 1086 | 1 | 1.0 to 1.1 | 1.4 to 1.5 |
| 1087 | 1 | 1.1 to 1.2 | 1.4 to 1.5 |
| 1088 | 1 | 1.2 to 1.3 | 1.4 to 1.5 |
| 1089 | 1 | 1.3 to 1.4 | 1.4 to 1.5 |
| 1090 | 1 | 1.4 to 1.5 | 1.4 to 1.5 |
| 1091 | 1 | 1.5 to 1.6 | 1.4 to 1.5 |
| 1092 | 1 | 1.6 to 1.7 | 1.4 to 1.5 |
| 1093 | 1 | 1.7 to 1.8 | 1.4 to 1.5 |
| 1094 | 1 | 1.8 to 1.9 | 1.4 to 1.5 |
| 1095 | 1 | 1.9 to 2.0 | 1.4 to 1.5 |
| 1096 | 1 | 2.0 to 2.1 | 1.4 to 1.5 |
| 1097 | 1 | 2.1 to 2.2 | 1.4 to 1.5 |
| 1098 | 1 | 2.2 to 2.3 | 1.4 to 1.5 |
| 1099 | 1 | 2.3 to 2.4 | 1.4 to 1.5 |
| 1100 | 1 | 2.4 to 2.5 | 1.4 to 1.5 |
| 1101 | 1 | 2.5 to 2.6 | 1.4 to 1.5 |
| 1102 | 1 | 2.6 to 2.7 | 1.4 to 1.5 |
| 1103 | 1 | 2.7 to 2.8 | 1.4 to 1.5 |
| 1104 | 1 | 2.8 to 2.9 | 1.4 to 1.5 |
| 1105 | 1 | 0.5 to 0.6 | 1.5 to 1.6 |
| 1106 | 1 | 0.6 to 0.7 | 1.5 to 1.6 |
| 1107 | 1 | 0.7 to 0.8 | 1.5 to 1.6 |
| 1108 | 1 | 0.8 to 0.9 | 1.5 to 1.6 |
| 1109 | 1 | 0.9 to 1.0 | 1.5 to 1.6 |
| 1110 | 1 | 1.0 to 1.1 | 1.5 to 1.6 |
| 1111 | 1 | 1.1 to 1.2 | 1.5 to 1.6 |
| 1112 | 1 | 1.2 to 1.3 | 1.5 to 1.6 |
| 1113 | 1 | 1.3 to 1.4 | 1.5 to 1.6 |
| 1114 | 1 | 1.4 to 1.5 | 1.5 to 1.6 |
| 1115 | 1 | 1.5 to 1.6 | 1.5 to 1.6 |
| 1116 | 1 | 1.6 to 1.7 | 1.5 to 1.6 |
| 1117 | 1 | 1.7 to 1.8 | 1.5 to 1.6 |
| 1118 | 1 | 1.8 to 1.9 | 1.5 to 1.6 |
| 1119 | 1 | 1.9 to 2.0 | 1.5 to 1.6 |
| 1120 | 1 | 2.0 to 2.1 | 1.5 to 1.6 |
| 1121 | 1 | 2.1 to 2.2 | 1.5 to 1.6 |
| 1122 | 1 | 2.2 to 2.3 | 1.5 to 1.6 |
| 1123 | 1 | 2.3 to 2.4 | 1.5 to 1.6 |
| 1124 | 1 | 2.4 to 2.5 | 1.5 to 1.6 |
| 1125 | 1 | 2.5 to 2.6 | 1.5 to 1.6 |
| 1126 | 1 | 2.6 to 2.7 | 1.5 to 1.6 |
| 1127 | 1 | 2.7 to 2.8 | 1.5 to 1.6 |
| 1128 | 1 | 2.8 to 2.9 | 1.5 to 1.6 |
| 1129 | 1 | 0.5 to 0.6 | 1.6 to 1.7 |
| 1130 | 1 | 0.6 to 0.7 | 1.6 to 1.7 |
| 1131 | 1 | 0.7 to 0.8 | 1.6 to 1.7 |
| 1132 | 1 | 0.8 to 0.9 | 1.6 to 1.7 |
| 1133 | 1 | 0.9 to 1.0 | 1.6 to 1.7 |
| 1134 | 1 | 1.0 to 1.1 | 1.6 to 1.7 |
| 1135 | 1 | 1.1 to 1.2 | 1.6 to 1.7 |
| 1136 | 1 | 1.2 to 1.3 | 1.6 to 1.7 |
| 1137 | 1 | 1.3 to 1.4 | 1.6 to 1.7 |
| 1138 | 1 | 1.4 to 1.5 | 1.6 to 1.7 |
| 1139 | 1 | 1.5 to 1.6 | 1.6 to 1.7 |
| 1140 | 1 | 1.6 to 1.7 | 1.6 to 1.7 |
| 1141 | 1 | 1.7 to 1.8 | 1.6 to 1.7 |
| 1142 | 1 | 1.8 to 1.9 | 1.6 to 1.7 |
| 1143 | 1 | 1.9 to 2.0 | 1.6 to 1.7 |
| 1144 | 1 | 2.0 to 2.1 | 1.6 to 1.7 |
| 1145 | 1 | 2.1 to 2.2 | 1.6 to 1.7 |
| 1146 | 1 | 2.2 to 2.3 | 1.6 to 1.7 |
| 1147 | 1 | 2.3 to 2.4 | 1.6 to 1.7 |
| 1148 | 1 | 2.4 to 2.5 | 1.6 to 1.7 |
| 1149 | 1 | 2.5 to 2.6 | 1.6 to 1.7 |
| 1150 | 1 | 2.6 to 2.7 | 1.6 to 1.7 |
| 1151 | 1 | 2.7 to 2.8 | 1.6 to 1.7 |
| 1152 | 1 | 2.8 to 2.9 | 1.6 to 1.7 |
| 1153 | 1 | 0.5 to 0.6 | 1.7 to 1.8 |
| 1154 | 1 | 0.6 to 0.7 | 1.7 to 1.8 |
| 1155 | 1 | 0.7 to 0.8 | 1.7 to 1.8 |
| 1156 | 1 | 0.8 to 0.9 | 1.7 to 1.8 |
| 1157 | 1 | 0.9 to 1.0 | 1.7 to 1.8 |
| 1158 | 1 | 1.0 to 1.1 | 1.7 to 1.8 |
| 1159 | 1 | 1.1 to 1.2 | 1.7 to 1.8 |
| 1160 | 1 | 1.2 to 1.3 | 1.7 to 1.8 |
| 1161 | 1 | 1.3 to 1.4 | 1.7 to 1.8 |
| 1162 | 1 | 1.4 to 1.5 | 1.7 to 1.8 |
| 1163 | 1 | 1.5 to 1.6 | 1.7 to 1.8 |
| 1164 | 1 | 1.6 to 1.7 | 1.7 to 1.8 |
| 1165 | 1 | 1.7 to 1.8 | 1.7 to 1.8 |
| 1166 | 1 | 1.8 to 1.9 | 1.7 to 1.8 |
| 1167 | 1 | 1.9 to 2.0 | 1.7 to 1.8 |
| 1168 | 1 | 2.0 to 2.1 | 1.7 to 1.8 |
| 1169 | 1 | 2.1 to 2.2 | 1.7 to 1.8 |
| 1170 | 1 | 2.2 to 2.3 | 1.7 to 1.8 |
| 1171 | 1 | 2.3 to 2.4 | 1.7 to 1.8 |
| 1172 | 1 | 2.4 to 2.5 | 1.7 to 1.8 |
| 1173 | 1 | 2.5 to 2.6 | 1.7 to 1.8 |
| 1174 | 1 | 2.6 to 2.7 | 1.7 to 1.8 |
| 1175 | 1 | 2.7 to 2.8 | 1.7 to 1.8 |
| 1176 | 1 | 2.8 to 2.9 | 1.7 to 1.8 |
| 1177 | 1 | 0.5 to 0.6 | 1.8 to 1.9 |
| 1178 | 1 | 0.6 to 0.7 | 1.8 to 1.9 |
| 1179 | 1 | 0.7 to 0.8 | 1.8 to 1.9 |
| 1180 | 1 | 0.8 to 0.9 | 1.8 to 1.9 |
| 1181 | 1 | 0.9 to 1.0 | 1.8 to 1.9 |
| 1182 | 1 | 1.0 to 1.1 | 1.8 to 1.9 |
| 1183 | 1 | 1.1 to 1.2 | 1.8 to 1.9 |
| 1184 | 1 | 1.2 to 1.3 | 1.8 to 1.9 |
| 1185 | 1 | 1.3 to 1.4 | 1.8 to 1.9 |
| 1186 | 1 | 1.4 to 1.5 | 1.8 to 1.9 |
| 1187 | 1 | 1.5 to 1.6 | 1.8 to 1.9 |
| 1188 | 1 | 1.6 to 1.7 | 1.8 to 1.9 |
| 1189 | 1 | 1.7 to 1.8 | 1.8 to 1.9 |
| 1190 | 1 | 1.8 to 1.9 | 1.8 to 1.9 |
| 1191 | 1 | 1.9 to 2.0 | 1.8 to 1.9 |
| 1192 | 1 | 2.0 to 2.1 | 1.8 to 1.9 |
| 1193 | 1 | 2.1 to 2.2 | 1.8 to 1.9 |
| 1194 | 1 | 2.2 to 2.3 | 1.8 to 1.9 |
| 1195 | 1 | 2.3 to 2.4 | 1.8 to 1.9 |
| 1196 | 1 | 2.4 to 2.5 | 1.8 to 1.9 |
| 1197 | 1 | 2.5 to 2.6 | 1.8 to 1.9 |
| 1198 | 1 | 2.6 to 2.7 | 1.8 to 1.9 |
| 1199 | 1 | 2.7 to 2.8 | 1.8 to 1.9 |
| 1200 | 1 | 2.8 to 2.9 | 1.8 to 1.9 |
| 1201 | 1 | 0.5 to 0.6 | 1.9 to 2.0 |
| 1202 | 1 | 0.6 to 0.7 | 1.9 to 2.0 |
| 1203 | 1 | 0.7 to 0.8 | 1.9 to 2.0 |
| 1204 | 1 | 0.8 to 0.9 | 1.9 to 2.0 |
| 1205 | 1 | 0.9 to 1.0 | 1.9 to 2.0 |
| 1206 | 1 | 1.0 to 1.1 | 1.9 to 2.0 |
| 1207 | 1 | 1.1 to 1.2 | 1.9 to 2.0 |
| 1208 | 1 | 1.2 to 1.3 | 1.9 to 2.0 |
| 1209 | 1 | 1.3 to 1.4 | 1.9 to 2.0 |
| 1210 | 1 | 1.4 to 1.5 | 1.9 to 2.0 |
| 1211 | 1 | 1.5 to 1.6 | 1.9 to 2.0 |
| 1212 | 1 | 1.6 to 1.7 | 1.9 to 2.0 |
| 1213 | 1 | 1.7 to 1.8 | 1.9 to 2.0 |
| 1214 | 1 | 1.8 to 1.9 | 1.9 to 2.0 |
| 1215 | 1 | 1.9 to 2.0 | 1.9 to 2.0 |
| 1216 | 1 | 2.0 to 2.1 | 1.9 to 2.0 |
| 1217 | 1 | 2.1 to 2.2 | 1.9 to 2.0 |
| 1218 | 1 | 2.2 to 2.3 | 1.9 to 2.0 |
| 1219 | 1 | 2.3 to 2.4 | 1.9 to 2.0 |
| 1220 | 1 | 2.4 to 2.5 | 1.9 to 2.0 |
| 1221 | 1 | 2.5 to 2.6 | 1.9 to 2.0 |
| 1222 | 1 | 2.6 to 2.7 | 1.9 to 2.0 |
| 1223 | 1 | 2.7 to 2.8 | 1.9 to 2.0 |
| 1224 | 1 | 2.8 to 2.9 | 1.9 to 2.0 |
| 1225 | 1 | 0.5 to 0.6 | 2.0 to 2.1 |
| 1226 | 1 | 0.6 to 0.7 | 2.0 to 2.1 |
| 1227 | 1 | 0.7 to 0.8 | 2.0 to 2.1 |
| 1228 | 1 | 0.8 to 0.9 | 2.0 to 2.1 |
| 1229 | 1 | 0.9 to 1.0 | 2.0 to 2.1 |
| 1230 | 1 | 1.0 to 1.1 | 2.0 to 2.1 |
| 1231 | 1 | 1.1 to 1.2 | 2.0 to 2.1 |
| 1232 | 1 | 1.2 to 1.3 | 2.0 to 2.1 |
| 1233 | 1 | 1.3 to 1.4 | 2.0 to 2.1 |
| 1234 | 1 | 1.4 to 1.5 | 2.0 to 2.1 |
| 1235 | 1 | 1.5 to 1.6 | 2.0 to 2.1 |
| 1236 | 1 | 1.6 to 1.7 | 2.0 to 2.1 |
| 1237 | 1 | 1.7 to 1.8 | 2.0 to 2.1 |
| 1238 | 1 | 1.8 to 1.9 | 2.0 to 2.1 |
| 1239 | 1 | 1.9 to 2.0 | 2.0 to 2.1 |
| 1240 | 1 | 2.0 to 2.1 | 2.0 to 2.1 |
| 1241 | 1 | 2.1 to 2.2 | 2.0 to 2.1 |
| 1242 | 1 | 2.2 to 2.3 | 2.0 to 2.1 |
| 1243 | 1 | 2.3 to 2.4 | 2.0 to 2.1 |
| 1244 | 1 | 2.4 to 2.5 | 2.0 to 2.1 |
| 1245 | 1 | 2.5 to 2.6 | 2.0 to 2.1 |
| 1246 | 1 | 2.6 to 2.7 | 2.0 to 2.1 |
| 1247 | 1 | 2.7 to 2.8 | 2.0 to 2.1 |
| 1248 | 1 | 2.8 to 2.9 | 2.0 to 2.1 |
| 1249 | 1 | 0.5 to 0.6 | 2.1 to 2.2 |
| 1250 | 1 | 0.6 to 0.7 | 2.1 to 2.2 |
| 1251 | 1 | 0.7 to 0.8 | 2.1 to 2.2 |
| 1252 | 1 | 0.8 to 0.9 | 2.1 to 2.2 |
| 1253 | 1 | 0.9 to 1.0 | 2.1 to 2.2 |
| 1254 | 1 | 1.0 to 1.1 | 2.1 to 2.2 |
| 1255 | 1 | 1.1 to 1.2 | 2.1 to 2.2 |
| 1256 | 1 | 1.2 to 1.3 | 2.1 to 2.2 |
| 1257 | 1 | 1.3 to 1.4 | 2.1 to 2.2 |
| 1258 | 1 | 1.4 to 1.5 | 2.1 to 2.2 |
| 1259 | 1 | 1.5 to 1.6 | 2.1 to 2.2 |
| 1260 | 1 | 1.6 to 1.7 | 2.1 to 2.2 |
| 1261 | 1 | 1.7 to 1.8 | 2.1 to 2.2 |
| 1262 | 1 | 1.8 to 1.9 | 2.1 to 2.2 |
| 1263 | 1 | 1.9 to 2.0 | 2.1 to 2.2 |
| 1264 | 1 | 2.0 to 2.1 | 2.1 to 2.2 |
| 1265 | 1 | 2.1 to 2.2 | 2.1 to 2.2 |
| 1266 | 1 | 2.2 to 2.3 | 2.1 to 2.2 |
| 1267 | 1 | 2.3 to 2.4 | 2.1 to 2.2 |
| 1268 | 1 | 2.4 to 2.5 | 2.1 to 2.2 |
| 1269 | 1 | 2.5 to 2.6 | 2.1 to 2.2 |
| 1270 | 1 | 2.6 to 2.7 | 2.1 to 2.2 |
| 1271 | 1 | 2.7 to 2.8 | 2.1 to 2.2 |
| 1272 | 1 | 2.8 to 2.9 | 2.1 to 2.2 |
| 1273 | 1 | 0.5 to 0.6 | 2.2 to 2.3 |
| 1274 | 1 | 0.6 to 0.7 | 2.2 to 2.3 |
| 1275 | 1 | 0.7 to 0.8 | 2.2 to 2.3 |
| 1276 | 1 | 0.8 to 0.9 | 2.2 to 2.3 |
| 1277 | 1 | 0.9 to 1.0 | 2.2 to 2.3 |
| 1278 | 1 | 1.0 to 1.1 | 2.2 to 2.3 |
| 1279 | 1 | 1.1 to 1.2 | 2.2 to 2.3 |
| 1280 | 1 | 1.2 to 1.3 | 2.2 to 2.3 |
| 1281 | 1 | 1.3 to 1.4 | 2.2 to 2.3 |
| 1282 | 1 | 1.4 to 1.5 | 2.2 to 2.3 |
| 1283 | 1 | 1.5 to 1.6 | 2.2 to 2.3 |
| 1284 | 1 | 1.6 to 1.7 | 2.2 to 2.3 |
| 1285 | 1 | 1.7 to 1.8 | 2.2 to 2.3 |
| 1286 | 1 | 1.8 to 1.9 | 2.2 to 2.3 |
| 1287 | 1 | 1.9 to 2.0 | 2.2 to 2.3 |
| 1288 | 1 | 2.0 to 2.1 | 2.2 to 2.3 |
| 1289 | 1 | 2.1 to 2.2 | 2.2 to 2.3 |
| 1290 | 1 | 2.2 to 2.3 | 2.2 to 2.3 |
| 1291 | 1 | 2.3 to 2.4 | 2.2 to 2.3 |
| 1292 | 1 | 2.4 to 2.5 | 2.2 to 2.3 |
| 1293 | 1 | 2.5 to 2.6 | 2.2 to 2.3 |
| 1294 | 1 | 2.6 to 2.7 | 2.2 to 2.3 |
| 1295 | 1 | 2.7 to 2.8 | 2.2 to 2.3 |
| 1296 | 1 | 2.8 to 2.9 | 2.2 to 2.3 |
| 1297 | 1 | 0.5 to 0.6 | 2.3 to 2.4 |
| 1298 | 1 | 0.6 to 0.7 | 2.3 to 2.4 |
| 1299 | 1 | 0.7 to 0.8 | 2.3 to 2.4 |
| 1300 | 1 | 0.8 to 0.9 | 2.3 to 2.4 |
| 1301 | 1 | 0.9 to 1.0 | 2.3 to 2.4 |
| 1302 | 1 | 1.0 to 1.1 | 2.3 to 2.4 |
| 1303 | 1 | 1.1 to 1.2 | 2.3 to 2.4 |
| 1304 | 1 | 1.2 to 1.3 | 2.3 to 2.4 |
| 1305 | 1 | 1.3 to 1.4 | 2.3 to 2.4 |
| 1306 | 1 | 1.4 to 1.5 | 2.3 to 2.4 |
| 1307 | 1 | 1.5 to 1.6 | 2.3 to 2.4 |
| 1308 | 1 | 1.6 to 1.7 | 2.3 to 2.4 |
| 1309 | 1 | 1.7 to 1.8 | 2.3 to 2.4 |
| 1310 | 1 | 1.8 to 1.9 | 2.3 to 2.4 |
| 1311 | 1 | 1.9 to 2.0 | 2.3 to 2.4 |
| 1312 | 1 | 2.0 to 2.1 | 2.3 to 2.4 |
| 1313 | 1 | 2.1 to 2.2 | 2.3 to 2.4 |
| 1314 | 1 | 2.2 to 2.3 | 2.3 to 2.4 |
| 1315 | 1 | 2.3 to 2.4 | 2.3 to 2.4 |
| 1316 | 1 | 2.4 to 2.5 | 2.3 to 2.4 |
| 1317 | 1 | 2.5 to 2.6 | 2.3 to 2.4 |
| 1318 | 1 | 2.6 to 2.7 | 2.3 to 2.4 |
| 1319 | 1 | 2.7 to 2.8 | 2.3 to 2.4 |
| 1320 | 1 | 2.8 to 2.9 | 2.3 to 2.4 |
| 1321 | 1 | 0.5 to 0.6 | 2.4 to 2.5 |
| 1322 | 1 | 0.6 to 0.7 | 2.4 to 2.5 |
| 1323 | 1 | 0.7 to 0.8 | 2.4 to 2.5 |
| 1324 | 1 | 0.8 to 0.9 | 2.4 to 2.5 |
| 1325 | 1 | 0.9 to 1.0 | 2.4 to 2.5 |
| 1326 | 1 | 1.0 to 1.1 | 2.4 to 2.5 |
| 1327 | 1 | 1.1 to 1.2 | 2.4 to 2.5 |
| 1328 | 1 | 1.2 to 1.3 | 2.4 to 2.5 |
| 1329 | 1 | 1.3 to 1.4 | 2.4 to 2.5 |
| 1330 | 1 | 1.4 to 1.5 | 2.4 to 2.5 |
| 1331 | 1 | 1.5 to 1.6 | 2.4 to 2.5 |
| 1332 | 1 | 1.6 to 1.7 | 2.4 to 2.5 |
| 1333 | 1 | 1.7 to 1.8 | 2.4 to 2.5 |
| 1334 | 1 | 1.8 to 1.9 | 2.4 to 2.5 |
| 1335 | 1 | 1.9 to 2.0 | 2.4 to 2.5 |
| 1336 | 1 | 2.0 to 2.1 | 2.4 to 2.5 |
| 1337 | 1 | 2.1 to 2.2 | 2.4 to 2.5 |
| 1338 | 1 | 2.2 to 2.3 | 2.4 to 2.5 |
| 1339 | 1 | 2.3 to 2.4 | 2.4 to 2.5 |
| 1340 | 1 | 2.4 to 2.5 | 2.4 to 2.5 |
| 1341 | 1 | 2.5 to 2.6 | 2.4 to 2.5 |
| 1342 | 1 | 2.6 to 2.7 | 2.4 to 2.5 |
| 1343 | 1 | 2.7 to 2.8 | 2.4 to 2.5 |
| 1344 | 1 | 2.8 to 2.9 | 2.4 to 2.5 |
| 1345 | 1 | 0.5 to 0.6 | 2.5 to 2.6 |
| 1346 | 1 | 0.6 to 0.7 | 2.5 to 2.6 |
| 1347 | 1 | 0.7 to 0.8 | 2.5 to 2.6 |
| 1348 | 1 | 0.8 to 0.9 | 2.5 to 2.6 |
| 1349 | 1 | 0.9 to 1.0 | 2.5 to 2.6 |
| 1350 | 1 | 1.0 to 1.1 | 2.5 to 2.6 |
| 1351 | 1 | 1.1 to 1.2 | 2.5 to 2.6 |
| 1352 | 1 | 1.2 to 1.3 | 2.5 to 2.6 |
| 1353 | 1 | 1.3 to 1.4 | 2.5 to 2.6 |
| 1354 | 1 | 1.4 to 1.5 | 2.5 to 2.6 |
| 1355 | 1 | 1.5 to 1.6 | 2.5 to 2.6 |
| 1356 | 1 | 1.6 to 1.7 | 2.5 to 2.6 |
| 1357 | 1 | 1.7 to 1.8 | 2.5 to 2.6 |
| 1358 | 1 | 1.8 to 1.9 | 2.5 to 2.6 |
| 1359 | 1 | 1.9 to 2.0 | 2.5 to 2.6 |
| 1360 | 1 | 2.0 to 2.1 | 2.5 to 2.6 |
| 1361 | 1 | 2.1 to 2.2 | 2.5 to 2.6 |
| 1362 | 1 | 2.2 to 2.3 | 2.5 to 2.6 |
| 1363 | 1 | 2.3 to 2.4 | 2.5 to 2.6 |
| 1364 | 1 | 2.4 to 2.5 | 2.5 to 2.6 |
| 1365 | 1 | 2.5 to 2.6 | 2.5 to 2.6 |
| 1366 | 1 | 2.6 to 2.7 | 2.5 to 2.6 |
| 1367 | 1 | 2.7 to 2.8 | 2.5 to 2.6 |
| 1368 | 1 | 2.8 to 2.9 | 2.5 to 2.6 |
| 1369 | 1 | 0.5 to 0.6 | 2.5 to 2.6 |
| 1370 | 1 | 0.6 to 0.7 | 2.5 to 2.6 |
| 1371 | 1 | 0.7 to 0.8 | 2.5 to 2.6 |
| 1372 | 1 | 0.8 to 0.9 | 2.5 to 2.6 |
| 1373 | 1 | 0.9 to 1.0 | 2.5 to 2.6 |
| 1374 | 1 | 1.0 to 1.1 | 2.5 to 2.6 |
| 1375 | 1 | 1.1 to 1.2 | 2.5 to 2.6 |
| 1376 | 1 | 1.2 to 1.3 | 2.5 to 2.6 |
| 1377 | 1 | 1.3 to 1.4 | 2.5 to 2.6 |
| 1378 | 1 | 1.4 to 1.5 | 2.5 to 2.6 |
| 1379 | 1 | 1.5 to 1.6 | 2.5 to 2.6 |
| 1380 | 1 | 1.6 to 1.7 | 2.5 to 2.6 |
| 1381 | 1 | 1.7 to 1.8 | 2.5 to 2.6 |
| 1382 | 1 | 1.8 to 1.9 | 2.5 to 2.6 |
| 1383 | 1 | 1.9 to 2.0 | 2.5 to 2.6 |
| 1384 | 1 | 2.0 to 2.1 | 2.5 to 2.6 |
| 1385 | 1 | 2.1 to 2.2 | 2.5 to 2.6 |
| 1386 | 1 | 2.2 to 2.3 | 2.5 to 2.6 |
| 1387 | 1 | 2.3 to 2.4 | 2.5 to 2.6 |
| 1388 | 1 | 2.4 to 2.5 | 2.5 to 2.6 |
| 1389 | 1 | 2.5 to 2.6 | 2.5 to 2.6 |
| 1390 | 1 | 2.6 to 2.7 | 2.5 to 2.6 |
| 1391 | 1 | 2.7 to 2.8 | 2.5 to 2.6 |
| 1392 | 1 | 2.8 to 2.9 | 2.5 to 2.6 |
| 1393 | 1 | 0.5 to 0.6 | 2.6 to 2.7 |
| 1394 | 1 | 0.6 to 0.7 | 2.6 to 2.7 |
| 1395 | 1 | 0.7 to 0.8 | 2.6 to 2.7 |
| 1396 | 1 | 0.8 to 0.9 | 2.6 to 2.7 |
| 1397 | 1 | 0.9 to 1.0 | 2.6 to 2.7 |
| 1398 | 1 | 1.0 to 1.1 | 2.6 to 2.7 |
| 1399 | 1 | 1.1 to 1.2 | 2.6 to 2.7 |
| 1400 | 1 | 1.2 to 1.3 | 2.6 to 2.7 |
| 1401 | 1 | 1.3 to 1.4 | 2.6 to 2.7 |
| 1402 | 1 | 1.4 to 1.5 | 2.6 to 2.7 |
| 1403 | 1 | 1.5 to 1.6 | 2.6 to 2.7 |
| 1404 | 1 | 1.6 to 1.7 | 2.6 to 2.7 |
| 1405 | 1 | 1.7 to 1.8 | 2.6 to 2.7 |
| 1406 | 1 | 1.8 to 1.9 | 2.6 to 2.7 |
| 1407 | 1 | 1.9 to 2.0 | 2.6 to 2.7 |
| 1408 | 1 | 2.0 to 2.1 | 2.6 to 2.7 |
| 1409 | 1 | 2.1 to 2.2 | 2.6 to 2.7 |
| 1410 | 1 | 2.2 to 2.3 | 2.6 to 2.7 |
| 1411 | 1 | 2.3 to 2.4 | 2.6 to 2.7 |
| 1412 | 1 | 2.4 to 2.5 | 2.6 to 2.7 |
| 1413 | 1 | 2.5 to 2.6 | 2.6 to 2.7 |
| 1414 | 1 | 2.6 to 2.7 | 2.6 to 2.7 |
| 1415 | 1 | 2.7 to 2.8 | 2.6 to 2.7 |
| 1416 | 1 | 2.8 to 2.9 | 2.6 to 2.7 |
| 1417 | 1 | 0.5 to 0.6 | 2.7 to 2.8 |
| 1418 | 1 | 0.6 to 0.7 | 2.7 to 2.8 |
| 1419 | 1 | 0.7 to 0.8 | 2.7 to 2.8 |
| 1420 | 1 | 0.8 to 0.9 | 2.7 to 2.8 |
| 1421 | 1 | 0.9 to 1.0 | 2.7 to 2.8 |
| 1422 | 1 | 1.0 to 1.1 | 2.7 to 2.8 |
| 1423 | 1 | 1.1 to 1.2 | 2.7 to 2.8 |
| 1424 | 1 | 1.2 to 1.3 | 2.7 to 2.8 |
| 1425 | 1 | 1.3 to 1.4 | 2.7 to 2.8 |
| 1426 | 1 | 1.4 to 1.5 | 2.7 to 2.8 |
| 1427 | 1 | 1.5 to 1.6 | 2.7 to 2.8 |
| 1428 | 1 | 1.6 to 1.7 | 2.7 to 2.8 |
| 1429 | 1 | 1.7 to 1.8 | 2.7 to 2.8 |
| 1430 | 1 | 1.8 to 1.9 | 2.7 to 2.8 |
| 1431 | 1 | 1.9 to 2.0 | 2.7 to 2.8 |
| 1432 | 1 | 2.0 to 2.1 | 2.7 to 2.8 |
| 1433 | 1 | 2.1 to 2.2 | 2.7 to 2.8 |
| 1434 | 1 | 2.2 to 2.3 | 2.7 to 2.8 |
| 1435 | 1 | 2.3 to 2.4 | 2.7 to 2.8 |
| 1436 | 1 | 2.4 to 2.5 | 2.7 to 2.8 |
| 1437 | 1 | 2.5 to 2.6 | 2.7 to 2.8 |
| 1438 | 1 | 2.6 to 2.7 | 2.7 to 2.8 |
| 1439 | 1 | 2.7 to 2.8 | 2.7 to 2.8 |
| 1440 | 1 | 2.8 to 2.9 | 2.7 to 2.8 |
| 1441 | 1 | 0.5 to 0.6 | 2.8 to 2.9 |
| 1442 | 1 | 0.6 to 0.7 | 2.8 to 2.9 |
| 1443 | 1 | 0.7 to 0.8 | 2.8 to 2.9 |
| 1444 | 1 | 0.8 to 0.9 | 2.8 to 2.9 |
| 1445 | 1 | 0.9 to 1.0 | 2.8 to 2.9 |
| 1446 | 1 | 1.0 to 1.1 | 2.8 to 2.9 |
| 1447 | 1 | 1.1 to 1.2 | 2.8 to 2.9 |
| 1448 | 1 | 1.2 to 1.3 | 2.8 to 2.9 |
| 1449 | 1 | 1.3 to 1.4 | 2.8 to 2.9 |
| 1450 | 1 | 1.4 to 1.5 | 2.8 to 2.9 |
| 1451 | 1 | 1.5 to 1.6 | 2.8 to 2.9 |
| 1452 | 1 | 1.6 to 1.7 | 2.8 to 2.9 |
| 1453 | 1 | 1.7 to 1.8 | 2.8 to 2.9 |
| 1454 | 1 | 1.8 to 1.9 | 2.8 to 2.9 |
| 1455 | 1 | 1.9 to 2.0 | 2.8 to 2.9 |
| 1456 | 1 | 2.0 to 2.1 | 2.8 to 2.9 |
| 1457 | 1 | 2.1 to 2.2 | 2.8 to 2.9 |
| 1458 | 1 | 2.2 to 2.3 | 2.8 to 2.9 |
| 1459 | 1 | 2.3 to 2.4 | 2.8 to 2.9 |
| 1460 | 1 | 2.4 to 2.5 | 2.8 to 2.9 |
| 1461 | 1 | 2.5 to 2.6 | 2.8 to 2.9 |
| 1462 | 1 | 2.6 to 2.7 | 2.8 to 2.9 |
| 1463 | 1 | 2.7 to 2.8 | 2.8 to 2.9 |
| 1464 | 1 | 2.8 to 2.9 | 2.8 to 2.9 |
| 1465 | 1 | 0.5 to 0.6 | 2.9 to 3.0 |
| 1466 | 1 | 0.6 to 0.7 | 2.9 to 3.0 |
| 1467 | 1 | 0.7 to 0.8 | 2.9 to 3.0 |
| 1468 | 1 | 0.8 to 0.9 | 2.9 to 3.0 |
| 1469 | 1 | 0.9 to 1.0 | 2.9 to 3.0 |
| 1470 | 1 | 1.0 to 1.1 | 2.9 to 3.0 |
| 1471 | 1 | 1.1 to 1.2 | 2.9 to 3.0 |
| 1472 | 1 | 1.2 to 1.3 | 2.9 to 3.0 |
| 1473 | 1 | 1.3 to 1.4 | 2.9 to 3.0 |
| 1474 | 1 | 1.4 to 1.5 | 2.9 to 3.0 |
| 1475 | 1 | 1.5 to 1.6 | 2.9 to 3.0 |
| 1476 | 1 | 1.6 to 1.7 | 2.9 to 3.0 |
| 1477 | 1 | 1.7 to 1.8 | 2.9 to 3.0 |
| 1478 | 1 | 1.8 to 1.9 | 2.9 to 3.0 |
| 1479 | 1 | 1.9 to 2.0 | 2.9 to 3.0 |
| 1480 | 1 | 2.0 to 2.1 | 2.9 to 3.0 |
| 1481 | 1 | 2.1 to 2.2 | 2.9 to 3.0 |
| 1482 | 1 | 2.2 to 2.3 | 2.9 to 3.0 |
| 1483 | 1 | 2.3 to 2.4 | 2.9 to 3.0 |
| 1484 | 1 | 2.4 to 2.5 | 2.9 to 3.0 |
| 1485 | 1 | 2.5 to 2.6 | 2.9 to 3.0 |
| 1486 | 1 | 2.6 to 2.7 | 2.9 to 3.0 |
| 1487 | 1 | 2.7 to 2.8 | 2.9 to 3.0 |
| 1488 | 1 | 2.8 to 2.9 | 2.9 to 3.0 |

Another property of the chemical vapor deposition coating 28 is its average thickness. The average thickness can be, for example, from 5 nm to 1000 nm thick, alternatively from 5 nm to 10 nm thick, alternatively from 10 nm to 20 nm thick, alternatively from 20 nm to 30 nm thick, alternatively from 30 nm to 40 nm thick, alternatively from 40 nm to 50 nm thick, alternatively from 50 nm to 100 nm thick, alternatively from 100 nm to 150 nm thick, alternatively from 150 nm to 200 nm thick, alternatively from 200 nm to 300 nm thick, alternatively from 300 nm to 400 nm thick, alternatively from 400 nm to 500 nm thick, alternatively from 500 nm to 600 nm thick, alternatively from 600 nm to 700 nm thick, alternatively from 700 nm to 800 nm thick, alternatively from 800 nm to 900 nm thick, alternatively from 900 nm to 1000 nm thick.

The chemical vapor deposition coatings 28 can have various purposes. As several examples: Optionally in any embodiment, the chemical vapor deposition coating 28 can be a barrier layer for oxygen, other gases, and solutes and contaminants in the wall 24. Optionally in any embodiment, the chemical vapor deposition coating 28 can be a pH protective layer. Optionally in any embodiment, the chemical vapor deposition coating 28 can be a lubricity layer, in the case of a contact surface 30 that is contacted by another relatively moving part, as for a syringe barrel and the relatively movable syringe plunger tip.

Optionally in any embodiment, the chemical vapor deposition coating 28 can be applied directly to the support surface 26, without intervening layers.

As another option, intervening coatings are optionally contemplated between the chemical vapor deposition coating 28 defining the contact surface 30 and the support surface 26, for various purposes. Several examples follow.

A tie layer 72 optionally can be provided between the chemical vapor deposition coating 28 and the support surface 26. A barrier layer 74 optionally can be provided between the chemical vapor deposition coating 28 and the support surface 26. A tie layer 72 and a barrier layer 74 optionally can be provided between the chemical vapor deposition coating 28 and the support surface 26. A barrier layer 74 and a pH protective layer 76 optionally can be provided between the chemical vapor deposition coating 28 and the support surface 26.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. An article of laboratory ware comprising:
a body made of thermoplastic material having a support surface;
a chemical vapor deposition coating applied directly or indirectly on the support surface, the coating defining a contact surface having a wetting tension of from 20 to 72 dyne/cm, and
a pH protective layer between the chemical vapor deposition coating and the support surface.

2. The invention of claim 1, in which the article comprises a plate, a vessel, or tubing.

3. The invention of claim 1, in which the article comprises at least one of the following:
a microplate;
a centrifuge tube;
a pipette tip;
a microwell plate;
an ELISA plate;
a microtiter plate;
a 96-well plate;
a 384-well plate.

4. The invention of claim 1, in which the article comprises a vessel having a lumen defined by a wall having an interior surface configured for containing a fluid, and at least a portion of the interior surface is the support surface on which the contact surface is supported.

5. The invention of claim 1, in which the article comprises tubing having a lumen defined by a wall having an interior surface configured for containing a fluid, and at least a portion of the interior surface is the support surface on which the contact surface is supported.

6. The invention of claim 1, in which the article comprises a pipette tip having a lumen defined by a wall having an interior surface configured for containing a fluid as the support surface on which the contact surface is supported.

7. The invention of claim 1, in which the article comprises a plate.

8. The invention of claim 7, in which the plate has a concave surface defining a well as the support surface on which the contact surface is supported.

9. The invention of claim 1, in which the thermoplastic material comprises:
an olefin polymer;
polypropylene (PP);
polyethylene (PE);
cyclic olefin copolymer (COC);
cyclic olefin polymer (COP);
polymethylpentene;
polyester;
polyethylene terephthalate;
polyethylene naphthalate;
polybutylene terephthalate (PBT);
PVdC (polyvinylidene chloride);
polyvinyl chloride (PVC);
polycarbonate;
polylactic acid;
polystyrene;
hydrogenated polystyrene;
poly(cyclohexylethylene) (PCHE);
epoxy resin;
nylon;
polyurethane polyacrylonitrile;
polyacrylonitrile (PAN);
an ionomeric resin;
Surlyn® ionomeric resin;
glass;
borosilicate glass.
or a combination of any two or more of these.

10. The invention of claim 1, in which the chemical vapor deposition process comprises at least one of: plasma enhanced chemical vapor deposition (PECVD); plasma impulse chemical vapor deposition (PICVD); pulsed plasma enhanced chemical vapor deposition (PPECVD); pyrolytic chemical vapor deposition (PCVD); hot filament chemical vapor deposition; and pyrolysis of hexafluoropropylene oxide.

11. The invention of claim 1, in which the contact surface formed by the chemical vapor deposition coating has at least one of the following properties:
reduced non-specific binding of peptides compared to the support surface before application of the chemical vapor deposition coating;
reduced non-specific binding of proteins compared to the support surface before application of the chemical vapor deposition coating;
reduced aggregation of protein based products compared to the support surface before application of the chemical vapor deposition coating;
reduced metal contaminants that can enter a sample contacting the support surface, compared to the support surface before application of the chemical vapor deposition coating;
enhanced solvent resistance compared to the support surface before application of the chemical vapor deposition coating;
reduced extractable compounds compared to the support surface before application of the chemical vapor deposition coating;
improved cleanliness compared to the support surface before application of the chemical vapor deposition coating; reduced particulates compared to the support surface before application of the chemical vapor deposition coating;
optical properties equivalent to or superior to glass compared to the support surface before application of the chemical vapor deposition coating;
reduced leachable metal contaminants compared to the support surface before application of the chemical vapor deposition coating;
low background noise compared to the support surface before application of the chemical vapor deposition coating; transparency;
reduced birefringence of images viewed through the support surface;
higher performance than standard polystyrene plates for fluorescence assays;
higher performance than standard polystyrene plates for luminescence detection;
higher performance than standard polystyrene plates for scintillation counting;
high-resolution microscopy using confocal imaging;
a tissue culture surface that increases the cell growth rate.

12. (canceled)

13. The invention of claim 1, in which the contact surface formed by the chemical vapor deposition coating is flat to <100 microns.

14. (canceled)

15. The invention of claim 1, in which the contact surface formed by the chemical vapor deposition coating has a contact angle suitable for contact with a selected protein.

16. The invention of claim 1, in which the contact surface formed by the chemical vapor deposition coating is configured for contact with a selected peptide, for example human, animal, porcine, or synthetic Insulin.

17. (canceled)

18. The invention of claim 1, in which the chemical vapor deposition coating is on average from 5 nm to 1000 nm thick.

19. The invention of claim 1, comprising a tie layer between the chemical vapor deposition coating and the support surface.

20. The invention of claim 1, comprising a barrier layer between the chemical vapor deposition coating and the support surface.

21. (canceled)

22. The invention of claim 1, in which the chemical vapor deposition coating is applied directly to the support surface, without intervening layers.
